(19) United States
(12) Patent Application Publication
(10) Pub. No.: US 2025/0147442 A1
(43) Pub. Date: May 8, 2025

(54) TONER

(71) Applicant: ZEON CORPORATION, Tokyo (JP)

(72) Inventors: Kojiro Akazaki, Tokyo (JP); Kohei Yamada, Tokyo (JP)

(73) Assignee: ZEON CORPORATION, Tokyo (JP)

(21) Appl. No.: 18/837,233

(22) PCT Filed: Feb. 13, 2023
(86) PCT No.: PCT/JP2023/004728

§ 371 Date: Aug. 9, 2024

(30) Foreign Application Priority Data
Feb. 16, 2022 (JP) 2022-022194
Feb. 28, 2022 (JP) 2022-029109

(51) Int. Cl. G03G 9/087; G03G 9/08; G03G 9/097

(52) U.S. Cl. CPC G03G 9/08797; G03G 9/0819; G03G 9/0821; G03G 9/097

(57) ABSTRACT

A toner comprising colored resin particles containing a binder resin, a colorant, a softening agent and a charge control agent, and an external additive, wherein the toner has a specific viscoelasticity; a conditioned bulk density obtained by use of a powder flowability analyzing device is 0.527 g/mL to 0.550 g/mL; and a flowability is 80% or more. Also, a toner comprising colored resin particles containing a binder resin, a colorant, a softening agent and a charge control agent, and an external additive containing fatty acid metal salt particles, wherein the toner has a specific viscoelasticity, and the ratio of a blow-off charge amount after a stirring time of 1800 seconds to a blow-off charge amount after a stirring time of 180 seconds, which are measured by a specific charge amount measurement method, is 0.50 to 1.00.

### TECHNICAL FIELD

The present disclosure relates to a toner which is used to develop an electrostatic latent image in, for example, electrophotography, electrostatic recording, and electrostatic printing.

### BACKGROUND ART

In an image forming device such as an electronic photographic device, an electrostatic recording device and an electrostatic printing device, first, an electrostatic latent image formed on the photoconductor is developed using a toner; the toner image is transferred onto a transferring material such as a sheet of paper; and the material is heated to fix the image, thereby obtaining a fixed image.

As such an image forming device, those corresponding to high image quality and high-speed printing are desired, and a toner capable of forming a high-quality image is desired. In recent years, there is an attempt to develop a toner by focusing on the viscoelasticity of the toner.

For example, Patent Document 1 discloses a toner such that, on the temperature dependence curve for a loss tangent (tan δ) of the toner, the glass transition temperature (Tg) satisfies 45° C.<Tg (° C.)<100° C., and the slope of a line passing through tan δ (45° C.) and tan δ (Tg) and that of a line passing through tan δ (100° C.) and tan δ (130° C.) are within specific ranges.

Patent Document 2 discloses a positively chargeable toner for developing electrostatic images, which contains, as external additives, specific amounts of the first and second silica fine particles each having a specific number average primary particle diameter and a specific triboelectric charge amount, and a specific amount of fatty acid metal salt particles.

Patent Document 3 describes that toner spouting is prevented and toner contamination inside the image forming apparatus is reduced by using, as an external additive, fatty acid metal salt particles having a water-soluble polymer added on their surface in a toner for use in an image forming apparatus including a cleaning brush and not including a cleaning blade.

Patent Document 4 discloses a toner comprising, as external additives, silica particles in combination with silicone resin particles, the silica particles being surface-hydrophobized and having a specific number average particle diameter, and the silicone resin particles having a specific number average particle diameter and a specific porosity.

### CITATION LIST

### Patent Documents

Patent Document 1: International Publication No. WO2021/153711
Patent Document 2: Japanese Patent Application Laid-Open (JP-A) No. 2011-133675
Patent Document 3: JP-A No. 2015-004802
Patent Document 4: International Publication No. WO2018/003749

### SUMMARY OF INVENTION

### Technical Problem

A toner capable of forming a high-quality image needs to be that both low-temperature fixability and storage stability are excellent in a good balance. Also, a toner having improved low-temperature fixability is likely to be easily spouted out from a developing roller. Accordingly, there is a demand for a toner having excellent low-temperature fixability, good storage stability, and capable of suppressing the occurrence of toner spouting.

However, toner spouting is likely to easily occur in a high temperature and high humidity environment. When the toners disclosed in Patent Documents 1 to 4 are used in continuous printing in a high temperature and high humidity environment, it is difficult to suppress the occurrence of toner spouting. Also, the toners disclosed in Patent Documents 2 to 4 are problematic in that their low-temperature fixability or storage stability is likely to be poor.

An object of the present disclosure is to provide a toner that is excellent in balance between low-temperature fixability and storage stability and is capable of suppressing the occurrence of spouting during continuous printing in a high temperature and high humidity environment.

### Solution to Problem

As a result of an extensive study to achieve the object, the inventor of the present disclosure found that a toner that is excellent in balance between low-temperature fixability and storage stability and is capable of suppressing the occurrence of spouting during continuous printing in a high temperature and high humidity environment, can be obtained by controlling the viscoelasticity of the toner, the value of the conditioned bulk density of the toner, which is obtained by use of a powder flowability analyzing device, and the value of the flowability of the toner. Finally, the inventor of the present disclosure achieved the toner of the first present disclosure.

The toner of the first present disclosure is a toner comprising colored resin particles containing a binder resin, a colorant, a softening agent and a charge control agent, and an external additive,
wherein a glass transition temperature (Tg) specified from a temperature dependence curve for a loss tangent (tan δ) of the toner, which is obtained by a dynamic viscoelastic measurement of the toner at a measurement frequency of 24 Hz, satisfies 65.0° C.≤Tg (C)≤75.0° C.;
wherein, in the temperature dependence curve for the loss tangent (tan δ) where tan δ (Tg) is a loss tangent (tan δ) at Tg and tan δ (100° C.) is a loss tangent (tan δ) at 100° C., an area of a trapezoid where the upper base, lower base and height are a value of tan δ (100° C.), a value of tan δ (Tg) and a value of 100−Tg, respectively, is 35.0 or more and 48.0 or less;
wherein a conditioned bulk density obtained by use of a powder flowability analyzing device is 0.527 g/mL or more and 0.550 g/mL or less; and
wherein a flowability is 80% or more.

Also, as a result of an extensive study to achieve the object, the inventors of the present disclosure found that a toner that is excellent in balance between low-temperature fixability and storage stability and is capable of suppressing the occurrence of spouting during continuous printing in a high temperature and high humidity environment, can be obtained by controlling the viscoelasticity of the toner and the ratio of the blow-off charge amount of the toner, which is obtained by a specific method, within specific ranges. Finally, the inventors of the present disclosure achieved the toner of the second present disclosure.

The toner of the second present disclosure is a toner comprising colored resin particles containing a binder resin, a colorant, a softening agent and a charge control agent, and an external additive,
wherein fatty acid metal salt particles are contained as the external additive;
wherein a glass transition temperature (Tg) specified from a temperature dependence curve for a loss tangent (tan δ) of the toner, which is obtained by a dynamic viscoelastic measurement of the toner at a measurement frequency of 24 Hz, satisfies 65.0° C.≤Tg (° C.)≤75.0° C.;
wherein, in the temperature dependence curve for the loss tangent (tan δ) where tan δ (Tg) is a loss tangent (tan δ) at Tg and tan δ (100° C.) is a loss tangent (tan δ) at 100° C., an area of a trapezoid where the upper base, lower base and height are a value of tan δ (100° C.), a value of tan δ (Tg) and a value of 100−Tg, respectively, is 35.0 or more and 48.0 or less; and
wherein a ratio of a blow-off charge amount of the toner after a stirring time of 1800 seconds to a blow-off charge amount of the toner after a stirring time of 180 seconds, both of which are measured by the following charge amount measurement method, is 0.50 or more and 1.00 or less:

### [Charge Amount Measurement Method]

first, 0.25 g of the toner and 9.75 g of a spherical, non-coated Mn—Mg—Sr—Fe type ferrite carrier having an average particle diameter of 60 μm, are put in a glass container having a volume of 30 cc (inner bottom diameter 30 mm, height 50 mm); in an environment at 23° C. and a relative humidity of 50%, a triboelectric charging treatment is carried out by stirring them by use of a roller mixer at a rotation of 160 rpm for a predetermined time; 0.2 g of a mixture of the toner and ferrite carrier after the triboelectric charging treatment, is put in a Faraday cage; and by use of a blow-off powder charge amount measuring device, the toner is blown off for 30 seconds in a condition of a nitrogen gas pressure of 0.098 MPa, and the blow-off charge amount (μC/g) of the toner is measured.

### Advantageous Effects of Invention

According to the present disclosure, a toner that is excellent in balance between low-temperature fixability and storage stability and is capable of suppressing the occurrence of spouting during continuous printing in a high temperature and high humidity environment, can be provided.

### BRIEF DESCRIPTION OF DRAWING

FIG. 1 is a graph showing the temperature dependence curve for the loss tangent (tan δ) of the toner of Example I-1 (equivalent to the toner of Example II-1).

### DESCRIPTION OF EMBODIMENTS

### I. Toner of the First Present Disclosure

The toner of the first present disclosure is a toner comprising colored resin particles containing a binder resin, a colorant, a softening agent and a charge control agent, and an external additive,
wherein a glass transition temperature (Tg) specified from a temperature dependence curve for a loss tangent (tan δ) of the toner, which is obtained by a dynamic viscoelastic measurement of the toner at a measurement frequency of 24 Hz, satisfies 65.0° C.≤Tg (° C.)≤75.0° C.;
wherein, in the temperature dependence curve for the loss tangent (tan δ) where tan δ (Tg) is a loss tangent (tan δ) at Tg and tan δ (100° C.) is a loss tangent (tan δ) at 100° C., an area of a trapezoid where the upper base, lower base and height are a value of tan δ (100° C.), a value of tan δ (Tg) and a value of 100−Tg, respectively, is 35.0 or more and 48.0 or less;
wherein a conditioned bulk density obtained by use of a powder flowability analyzing device is 0.527 g/mL or more and 0.550 g/mL or less; and
wherein a flowability is 80% or more.

As for the toner of the first present disclosure, the toner has such specific viscoelasticity, that the glass transition temperature (Tg) specified from the temperature dependence curve for the loss tangent (tan δ) is 65.0° C. or more and 75.0° C. or less and that the area of the trapezoid, which is specified from the temperature dependence curve for the loss tangent (tan δ), is 35.0 or more and 48.0 or less; the toner has a conditioned bulk density (hereinafter may be referred to as CBD), which is obtained by use of a powder flowability analyzing device, of 0.527 g/mL or more and 0.550 g/mL or less; and the toner has a flowability of 80% or more. Accordingly, the toner is a toner such that both the low-temperature fixability and the storage stability are improved in a well-balanced manner, and that spouting of the toner when enduring in a high temperature and high humidity environment, is suppressed. The toner has excellent performance which has been difficult to realize in the past.

In the present disclosure, the temperature dependence curve for the loss tangent (tan δ) obtained by the dynamic viscoelasticity measurement may be referred to as “temperature-tan δ curve”.

Toner spouting occurs for the following reasons, for example. When heat is generated by the sliding of a developing roller and is locally applied to a toner accumulated in the vicinity of the blade or sealing part of a cartridge, the accumulated toner is thermofused into an aggregate, and the aggregate melts and spouts from the developing roller, thereby causing the toner to spout out. Toner spouting is likely to occur in a high temperature and high humidity environment, since the flowability of the toner is decreased by the moisture absorption of the toner, and heat is further applied to the toner in the high temperature environment.

Meanwhile, during a fixing process or storage, a toner does not deform suddenly when it reaches a certain temperature; however, it gradually deforms along with increased temperature or with the lapse of time in which it is kept at a certain temperature. Based on these properties of the toner, the present inventor found the following: the characteristics of a toner such that the low-temperature fixability and the storage stability are in good balance and toner spouting can be easily suppressed, appear in the glass transition temperature (Tg) and the area of the trapezoid, which are specified from the temperature-tan δ curve. In addition, the present inventor found that, by controlling the CBD and flowability of the toner, spouting of the toner can be suppressed even when enduring in a high temperature and high humidity environment.

First, by controlling the Tg of the toner and the area of the trapezoid, both of which are specified from the temperature-tan δ curve, within the ranges specified above, the low-temperature fixability and the storage stability can be improved in a well-balanced manner. When the Tg of the toner is too high or when the area of the trapezoid is too small, the toner is likely to be poor in low-temperature fixability. When the Tg of the toner is too low or when the area of the trapezoid is too large, the toner is likely to be poor in storage stability due to easy occurrence of blocking during storage.

The area of the trapezoid specified from the temperature-tan δ curve is obtained by simply integrating the viscous terms of between the glass transition temperature (Tg) of the toner and 100° C. As the area of the trapezoid increases, the toner is more likely to aggregate. Accordingly, the area of the trapezoid can be used as the index of the aggregability of the toner, when toner accumulation is formed. The toner in which the area of the trapezoid is 35.0 or more and 48.0 or less, is less likely to aggregate even when it accumulates.

The CBD can be used as the index of the stiffness of the toner accumulation (i.e., the hardness of a toner mass). As the CBD decreases, the toner is more likely to collapse even when it accumulates. Accordingly, the toner is less likely to aggregate. On the other hand, when the CBD is too small, the toner is likely to leak from the toner accumulation. As far as the CBD is within the above range, the leakage of the toner does not immediately occur even when the toner accumulates, and an aggregate is hardly formed. In addition, since the flowability of the toner of the first present disclosure is 80% or more and sufficiently high, the toner hardly accumulates, and an aggregate of the toner is hardly formed.

Therefore, by controlling the Tg and the area of the trapezoid, which are specified from the temperature-tan δ curve at a measurement frequency of 24 Hz, within the above-specified ranges, and by controlling the CBD value and the flowability value as described above, the toner of the first present disclosure can be a toner having the following characteristics: the toner is excellent in balance between low-temperature fixability and storage stability; the toner is less likely to accumulate; spouting of the toner does not occur immediately even when the toner accumulates; and the toner is less likely to aggregate since the accumulated toner is likely to collapse; and aggregation and melting of the toner are suppressed. As a result of these characteristics, spouting of the toner is remarkably suppressed, and the occurrence of spouting of the toner can be suppressed even when enduring in a high temperature and high humidity environment.

Hereinafter, the characteristics of the toner of the first present disclosure, a method for producing colored resin particles used for the toner of the first present disclosure, the colored resin particles, an external additive used for the toner of the first present disclosure, a method for adding the external additive, and the performance of the toner of the first present disclosure, will be described in this order.

In the present disclosure, “to” in a numerical range is used to describe a range in which the numerical values described before and after “to” indicate the lower limit value and the upper limit value.

### I-1. Characteristics of the Toner

### [Viscoelasticity]

As for the toner of the first present disclosure, the glass transition temperature (Tg) specified from the temperature dependence curve for the loss tangent (tan δ) of the toner, which is obtained by the dynamic viscoelastic measurement of the toner at a measurement frequency of 24 Hz, satisfies 65.0° C.≤Tg (° C.)≤75.0° C., and the area of the trapezoid where the upper base, the lower base and the height are the value of tan δ (100° C.), the value of tan δ (Tg) and the value of 100−Tg, respectively, is 35.0 or more and 48.0 or less.

In the present disclosure, the loss tangent (tan δ) is defined as the ratio (G″/G′) of the storage elastic modulus (G′) and the loss elastic modulus (G″) measured by the dynamic viscoelastic measurement.

In the toner of the first present disclosure, the shape of the temperature-tan δ curve in a temperature range of 45° C. or more and 190° C. or less at a measurement frequency of 24 Hz, may have the following characteristics, for example. The curve has at least one peak in a range of 65.0° C. or more and 75.0° C. or less; after the temperature exceeds the temperature at which the tan δ becomes the maximum value of the peak, the tan δ decreases with increasing temperature to reach the minimum value; the tan δ gradually increases from the temperature at which the tan δ reaches the minimum value as the temperature further increases; and then, the tan δ becomes a substantially constant value above a certain temperature.

In the present disclosure, the dynamic viscoelastic measurement is carried out using a rotating flat plate rheometer (product name: ARES-G2, manufactured by: TA Instruments Inc.) and using a parallel plate or a cross-hatch plate under the following conditions.

### Frequency: 24 Hz

Sample set: A test piece (2 mm to 4 mm thick) is sandwiched between 8 mm φ plates with a 20 g load; the test piece is fused to a jig by increasing the temperature to 80° C.; the temperature is returned to 45° C.; then, increasing the temperature (temperature increase) is started.
Temperature increase rate: 5° C./min
Temperature range: 40° C. to 190° C.

For example, the test piece can be produced by pouring 0.2 g of the toner of the present disclosure into a cylindrical mold of 8 mm φ and pressurizing the toner at 1.0 MPa for 30 seconds, thereby forming a columnar molded product having a diameter of 8 mm φ and a thickness of 2 mm to 4 mm.

In the present disclosure, the value of the tan δ is rounded to the second decimal place according to the rule B of JIS 28401:1999. The tan δ values used for the calculation of the area of the trapezoid are also rounded to the second decimal place. The value of 100−Tg used for the calculation of the area of the trapezoid is rounded to the first decimal place. The value of the area of the trapezoid is rounded to the first decimal place.

In the present disclosure, the glass transition temperature (Tg) specified from the temperature-tan δ curve at a measurement frequency of 24 Hz, is specified as the lowest temperature at which the tan δ is the maximum value in the peak of the lowest temperature side among one or more peaks in the temperature range of higher than 45° C. of the temperature dependence curve for the loss tangent (tan δ) obtained by the dynamic viscoelastic measurement of the toner at a measurement frequency of 24 Hz. Fine vertical fluctuations (such as noise) caused by the measurement are not interpreted as the above-mentioned peaks.

In the toner of the first present disclosure, since the glass transition temperature (Tg) specified from the temperature-tan δ curve at a measurement frequency of 24 Hz is 65.0° C. or more, an abrupt decrease in modulus at a low temperature is suppressed. In addition, since the area of the trapezoid is 48.0 or less, aggregation of the toner is suppressed. Accordingly, blocking of the toner is suppressed, and the toner can be a toner with improved storage stability.

Moreover, in the toner of the first present disclosure, since the glass transition temperature (Tg) specified from the temperature-tan δ curve at a measurement frequency of 24 Hz is 75.0° C. or less, the softening start temperature of the toner does not become too high. In addition, since the area of the trapezoid is 35.0 or more, the fixability of the toner is excellent. Accordingly, the toner can be a toner with improved low-temperature fixability. From the viewpoint of low-temperature fixability, the Tg may be 77° C. or less. However, when it satisfies 65.0° C.≤Tg (C)≤75.0° C., the area of the trapezoid can easily fall within a range of 35.0 or more and 48.0 or less.

When the area of the trapezoid is too large, the toner is likely to aggregate when it accumulates. Accordingly, spouting of the toner is likely to occur. On the other hand, when the area of the trapezoid is 35.0 or more and 48.0 or less, the toner is less likely to aggregate even when accumulates. Accordingly, spouting of the toner is suppressed.

The glass transition temperature (Tg) is preferably 67.0° C. or more, and more preferably 69.0° C. or more. On the other hand, it is preferably 73.0° C. or less, and more preferably 71.0° C. or less.

The area of the trapezoid is preferably 37.0 or more, and more preferably 39.0 or more. On the other hand, it is preferably 46.0 or less, and more preferably 45.0 or less.

In the present disclosure, the trapezoid is a trapezoid ABCD where, in the temperature-tan δ curve, the point of tan δ (100° C.) is the point A; the point of tan δ (Tg) is the point B; the intersection where the perpendicular from the point A to the horizontal axis (tan δ=0) intersects the horizontal axis, is the point D; and the intersection where the perpendicular from the point B to the horizontal axis (tan δ=0) intersects the horizontal axis, is the point C. In the trapezoid ABCD, the upper base is the line segment AD; the lower base is the line segment BC; and the height is the length of the line segment CD. Accordingly, the area of the trapezoid ABCD is calculated by the common calculation formula for the area of a trapezoid: “(upper base+lower base)×height/2”, using the value of tan δ (100° C.), the value of tan δ (Tg) and the value of 100−Tg as the upper base, the lower base and the height, respectively. The value of 100−Tg is the difference between 100° C. and Tg (° C.); however, the value has no unit in the calculation of the area of the trapezoid since it is considered as the height.

Also in the first present disclosure, the tan δ (Tg) of the toner is preferably 1.50 or more, more preferably 1.60 or more, and still more preferably 1.70 or more. On the other hand, it is preferably 2.60 or less, more preferably 2.30 or less, still more preferably 2.00 or less, and even more preferably 1.90 or less.

The tan δ (Tg) represents the deformability of the toner when a local temperature increase occurs. As the tan δ (Tg) increases, the toner is more likely to deform and enter spaces when pressure is applied. When the tan δ (Tg) is equal to or more than the lower limit value, the toner fixability easily becomes excellent. When the tan δ (Tg) is equal to or less than the upper limit value, the storage stability of the toner can be easily improved due to the suppression of blocking during storage, and the occurrence of spouting of the toner in a high temperature and high humidity environment can be easily suppressed. In addition, when the tan δ (Tg) is within the above range, the area of the trapezoid can easily fall within the above range.

Also in the first present disclosure, the tan δ (100° C.) of the toner is preferably 0.75 or more, more preferably 0.80 or more, and still more preferably 0.82 or more. On the other hand, it is preferably 1.00 or less, more preferably 0.97 or less, and still more preferably 0.95 or less.

When the tan δ (100° C.) is equal to or more than the lower limit value, the fixability easily becomes excellent. When the tan δ (100° C.) is equal to or less than the upper limit value, a deterioration in the storage stability of the toner can be easily suppressed, and the occurrence of spouting of the toner can be easily suppressed. When the tan δ (100° C.) is within the above range, the area of the trapezoid can easily fall within the above range.

### [CBD]

The conditioned bulk density (CBD) of the toner of the first present disclosure, which is obtained by use of a powder flowability analyzing device, is 0.527 g/mL or more and 0.550 g/mL or less. In the toner of the first present disclosure, since the CBD is equal to or more than the lower limit value, spouting of the toner does not immediately occur even when the toner is accumulated. On the other hand, since the CBD is equal to or less than the upper limit value, the accumulated toner is likely to collapse, and aggregation of the toner is suppressed, accordingly.

As the powder flowability analyzing device (hereinafter, it may be referred to as “analyzing device”), for example, FT4 POWDER RHEOMETER (product name, manufactured by Freeman Technology) can be used.

In the present disclosure, conditioning corresponds to a toner packing operation. Accordingly, the conditioned bulk density is a simulated bulk density of the toner that is densely packed in the toner accumulation that is formed at the time of toner development.

In the case of measuring the CBD of the toner, prior art documents relating to powder flowability analyzing devices, etc., can be used as a reference. For example, prior art documents such as “Powder flowability analyzing device FT4 POWDER RHEOMETER academic materials” (published by Scientific Instrumentation Business Division of Sysmex Corporation, the first edition published on Sep. 1, 2007) (see especially pages 6, 7 and 10) can be used as a reference. Note that the CBD used in the present disclosure is not limited to only the contents described in the prior patent documents.

As the conditioning method that is carried out in the measurement of the CBD of the toner, examples include, but are not limited to, a method in which, following the first step, a series of the second to fifth steps described below are carried out for 3 cycles.

### (First Step)

First, 100 g of the toner is packed in a conditioning container (inner diameter 50 mm, total height 140 mm) and left to stand for 10 minutes as it is, thereby forming a toner layer.

### (Second Step)

The tip speed and entry angle of the blades of the analyzing device are set to the following speed and angle. With stirring the toner layer, the blades are inserted into the toner layer from the surface of the toner layer, until it reaches a position 10 mm above the bottom of the conditioning container. The entry angle of the blades is an angle made by the meeting of the toner layer surface with a spiral path drawn by the blades.
Tip speed of the blades: 60 mm/sec
Entry angle of the blades: 5° in clockwise direction

### (Third Step)

The entry angle of the blades is changed to 2° in clockwise direction, without changing the tip speed of the blades. While stirring the toner layer, the blades are moved down to a position 1 mm above the bottom of the conditioning container.

### (Forth Step)

The entry angle of the blades is changed to 5° in anticlockwise direction, without changing the tip speed of the blades. While stirring the toner layer, the blades are moved up to a position 100 mm above the bottom of the conditioning container.

### (Fifth Step)

The blades are raised from the toner layer surface.

When the second step is carried out after the fifth step, excess toner attached to the blades raised from the toner layer surface in the fifth step, is shaken off.

As the conditioning container, conditioning container is preferably used, that an ancillary container, which has a side only, is placed on the top of a measurement container, which has a bottom and a side, and connected thereto. As the conditioning container, examples include, but are not limited to, a container composed of a cylindrical ancillary container, which has a side only, is placed on the top of a cylindrical measurement container, which has a bottom furnished with a clamp, and connected thereto by a splitter. By using such a conditioning container, only the ancillary container can be detached after the conditioning of the toner. By detaching the ancillary container and, at the same time, leveling off the toner above the edge of the measurement container, a toner cake having the same volume as the measurement container can be produced.

The CBD of the toner can be calculated by dividing the mass of the obtained toner cake by the volume of the measurement container.

### [Flowability]

The flowability of the toner of the first present disclosure is 80% or more. Accordingly, the toner of the first present disclosure is less likely to form toner accumulation, and a deterioration in print quality is suppressed.

In the present disclosure, the flowability of the toner is measured by the following method.

Three kinds of sieves having different opening sizes (150 μm, 75 μm and 45 μm) are stacked in this order from top to bottom. Next, 4 g of the toner is weighed as precisely as possible and placed on the top sieve. Then, the stacked three sieves are oscillated for 15 seconds at an amplitude of 0.30 mm, using a powder characteristic tester (such as POWDER TESTER (registered trademark), model: PT-X, manufactured by: Hosokawa Micron Corporation). Then, the weight of the toner remaining on each sieve is measured. The measured values are plugged into the following calculation formula 1 to obtain the values of a, b and c. Next, the a, b and c values are plugged into the calculation formula 2 to calculate the value of the flowability in percentage. Each sample is measured three times, and the average is determined as the value of the flowability of the toner.

$$a = [ ( Weight ( g ) of the toner remaining on the 150 μ m sieve ) / 4 g ] \times 100 \qquad Calculation formula 1 :$$

$$b = [ \text{} ( Weight ( g ) of the toner remaining on the 75 μ m sieve ) / 4 g ] \times 100 \times 0.6$$

$$c = [ \text{} ( Weight ( g ) of the toner remaining on the 45 μ m sieve ) / 4 g ] \times 100 \times 0.2$$

$$Flowability ( \% ) = 100 - ( a + b + c ) \qquad Calculation formula 2 :$$

### [BET Specific Surface Area]

The BET specific surface area of the toner of the first present disclosure is not particularly limited. The BET specific surface area is preferably 1.00 m²/g or more, more preferably 1.50 m²/g or more, and still more preferably 1.70 m²/g or more. On the other hand, the BET specific surface area is preferably 2.00 m²/g or less, and more preferably 1.90 m²/g or less. The BET specific surface area of the toner can be used as the index of the state of the added external additive. When the BET specific surface area of the toner is within the above range, the external additive is appropriately added on the colored resin particles. Accordingly, the balance between the low-temperature fixability and the storage stability and the flowability easily become excellent. When the BET specific surface area of the toner is less than the lower limit value, the amount of the external additive is too small, or the external additive penetrates excessively to the inside of the colored resin particles. As a result, the blocking resistance may deteriorate, or the flowability may decrease, and spouting of the toner is likely to easily occur. On the other hand, when the BET specific surface area of the toner is more than the upper limit value, the amount of the added external additive is too large. Accordingly, the low-temperature fixability may deteriorate.

The BET specific surface area of the toner can be measured by known methods. For example, the BET specific surface area of the toner can be measured by a nitrogen adsorption method (BET method) using a BET specific surface area measuring device (product name: MACSORB HM MODEL-1208, manufactured by: Mountech Co., Ltd.) or the like.

The toner of the first present disclosure having the above-described characteristics can be obtained by controlling, for example, the composition, molecular weight and content of the binder resin contained in the toner, the type and content of the external additive, and the toner production condition such as the external addition treatment condition. The viscoelasticity of the toner can be controlled mainly by controlling the composition, molecular weight and content of the binder resin, and the type and content of the external additive. The CBD and flowability of the toner can be controlled mainly by controlling the type and amount of the added external additive, and the external addition treatment condition. As the external addition treatment condition becomes milder (e.g., the peripheral speed of the stirring blades is slow or the external addition treatment time is short in the external addition treatment), the CBD of the toner is likely to decrease, and the flowability is likely to be lower. On the other hand, as the external addition treatment condition becomes severer (e.g., the peripheral speed of the stirring blades is fast or the external addition treatment time is long), the CBD of the toner is likely to increase, and the flowability is likely to be higher. Also, the CBD is likely to larger, and the flowability is likely to higher, when the external addition treatment is carried out in two steps, rather than in one step.

To obtain the toner of the first present disclosure having the above-described characteristics, more specifically, it is effective to employ the below-described preferred embodiments as the components used for the toner production, and to bring the external addition treatment condition in line with the preferred condition described below.

### 1-2. Method for Producing Colored Resin Particles

In general, methods for producing colored resin particles are broadly classified into dry methods such as a pulverization method and wet methods such as an emulsion polymerization agglomeration method, a suspension polymerization method and a dissolution suspension method. The wet methods are preferred since a toner having excellent printing characteristics such as image reproducibility, can be easily obtained. Among the wet methods polymerization methods such as an emulsion polymerization agglomeration method and a suspension polymerization method are preferred, since a toner having a relatively small particle size distribution in micron order can be easily obtained. Among the polymerization methods, a suspension polymerization method is more preferred.

In the emulsion polymerization aggregation method, a polymerizable monomer emulsified is polymerized to obtain a resin fine particle emulsion, and is aggregated with a colorant dispersion or the like, thereby obtaining colored resin particles. In the dissolution suspension method, a solution in which toner components such as a binder resin and a colorant are dissolved or dispersed in an organic solvent is formed into liquid droplets in an aqueous medium, and the organic solvent is removed, thereby obtaining colored resin particles. As those methods, known methods can be used.

The colored resin particles used in the toner of the first present disclosure can be produced by using a wet method or a dry method, and a wet method is preferably used. The colored resin particles can be produced by the following processes using a suspension polymerization method which is particularly preferable among the wet methods.

### (A) Suspension Polymerization Method

### (A-1) Preparation Step of Polymerizable Monomer Composition

First, a polymerizable monomer, a colorant, a softening agent, a charge control agent, and other additives such as a molecular weight modifier if necessary are mixed to prepare a polymerizable monomer composition. For example, a media type dispersing machine is used for the mixing in the preparation of the polymerizable monomer composition.

In the present disclosure, the polymerizable monomer is a monomer having a polymerizable functional group. Polymerizable monomers are polymerized to become a binder resin. As the main component of the polymerizable monomer, a monovinyl monomer is preferably used. Examples of the monovinyl monomer include, but are not limited to, styrene; styrene derivatives such as vinyltoluene and α-methylstyrene; acrylic acid and methacrylic acid; acrylic esters such as methyl acrylate, ethyl acrylate, propyl acrylate, butyl acrylate, 2-ethylhexyl acrylate and dimethylaminoethyl acrylate; methacrylic esters such as methyl methacrylate, ethyl methacrylate, propyl methacrylate, butyl methacrylate, 2-ethylhexyl methacrylate and dimethylaminoethyl methacrylate; nitrile compounds such as acrylonitrile and methacrylonitrile; amide compounds such as acrylamide and methacrylamide; and olefins such as ethylene, propylene and butylene.

The monovinyl monomers may be used alone or in combination of two or more thereof.

From the viewpoint that the toner having the above-specified viscoelasticity can be easily obtained, the polymerizable monomer preferably includes at least one kind of monovinyl monomer selected from the group consisting of styrene, styrene derivatives, acrylic esters and methacrylic esters, more preferably includes at least one kind of monovinyl monomer selected from the group consisting of styrene, acrylic esters and methacrylic esters, and still more preferably includes styrene and at least one kind selected from the group consisting of acrylic esters and methacrylic esters.

Among the acrylic esters, at least one selected from the group consisting of n-butyl acrylate, propyl acrylate and 2-ethylhexyl acrylate is preferred, and among the methacrylic esters, at least one selected from the group consisting of n-butyl methacrylate, propyl methacrylate 2-ethylhexyl methacrylate is preferred.

From the point of view that the toner having the above-specified viscoelasticity can be easily obtained, the content of styrene in a total of 100 parts by mass of the monovinyl monomers is preferably 60 parts by mass or more, and more preferably 70 parts by mass or more. On the other hand, the styrene content is preferably 90 parts by mass or less, and more preferably 80 parts by mass or less.

From the viewpoint that the toner having the above-specified viscoelasticity can be easily obtained, it is preferable that the monovinyl monomer includes styrene and at least one selected from the group consisting of acrylic acid esters and methacrylic acid esters, and the mass ratio of styrene to the total mass of acrylic acid esters and methacrylic acid esters (styrene:(meth)acrylic acid esters) is within the range of 50:50 to 90:10. The mass ratio (styrene:(meth)acrylic acid esters) is more preferably within the range of 60:40 to 80:20.

When the polymerizable monomer includes a polymerizable monomer other than the monovinyl monomer, the content of the monovinyl monomer is appropriately adjusted so as to have the above-specified viscoelasticity, and it is not particularly limited. The total amount of the monovinyl monomer is preferably 90 parts by mass or more, and more preferably 95 parts by mass or more, per 100 parts by mass of the total amount of the polymerizable monomer.

The polymerizable monomer preferably contains a crosslinkable polymerizable monomer in combination with the monovinyl monomer. When the polymerizable monomer contains an optional crosslinkable polymerizable monomer, the toner having the above-specified viscoelasticity can be easily obtained, and the hot offset resistance and the storage stability can be improved.

The crosslinkable polymerizable monomer is a monomer having two or more polymerizable functional groups. Examples of the crosslinkable polymerizable monomer include, but are not limited to, aromatic divinyl compounds such as divinyl benzene, divinyl naphthalene and derivatives thereof; ester compounds such as ethylene glycol dimethacrylate and diethylene glycol dimethacrylate, in which two or more carboxylic acids are esterified to an alcohol having two or more hydroxyl groups; other divinyl compounds such as N, N-divinylaniline and divinyl ether; and compounds having three or more vinyl groups. The crosslinkable polymerizable monomers may be used alone or in combination of two or more thereof.

The content of the crosslinkable polymerizable monomer is appropriately adjusted so that the toner obtains the above-specified viscoelasticity, and it is not particularly limited. With respect to 100 parts by mass of the monovinyl monomer, the content of the crosslinkable polymerizable monomer is generally from 0.1 parts by mass to 5.0 parts by mass, preferably from 0.3 parts by mass to 2.0 parts by mass, and more preferably from 0.5 parts by mass to 1.0 part by mass.

The polymerizable monomer preferably includes a macromonomer in combination with the monovinyl monomer. When the polymerizable monomer includes a macromonomer, the toner having the above-specified viscoelasticity can be easily obtained, and the balance between the storage stability and low-temperature fixability of the toner can be improved.

As the macromonomer, examples include a reactive oligomer or polymer which has a polymerizable carbon-carbon unsaturated double bond at the end of the molecular chain and which has a number average molecular weight of generally from 1,000 to 30,000. As the macromonomer, examples include a styrene macromonomer, a styrene-acrylonitrile macromonomer, a polyacrylic ester macromonomer and a polymethacrylic ester macromonomer. Among them, at least one selected from a polyacrylic ester macromonomer and a polymethacrylic ester macromonomer is preferably used, since it is easy to control the glass transition temperature (Tg) on the temperature-tan δ curve within the above-specified range. As the acrylic ester used in the polyacrylic ester macromonomer, examples include the above-mentioned acrylic esters usable as the monovinyl monomer. As the methacrylic ester used in the polymethacrylic ester macromonomer, examples include the above-mentioned methacrylic esters usable as the monovinyl monomer. As the macromonomer, it is preferable to appropriately select and use such a macromonomer, that when the polymerizable monomer includes the macromonomer, the glass transition temperature (To) of the obtained binder resin becomes higher than the case where the polymerizable monomer does not include the macromonomer. This is because the glass transition temperature (Tg) on the temperature-tan δ curve can easily fall within the preferable range.

As the macromonomer, a commercially-available product may be used. Examples of the commercially-available product of the macromonomer include macromonomer series AA-6, AS-6, AN-6S, AB-6 and AW-6S manufactured by TOAGOSEI Co., Ltd.

The macromonomers may be used alone or in combination of two or more thereof.

When the polymerizable monomer includes the macromonomer, the content of the macromonomer is appropriately adjusted so that the toner obtains the above-specified viscoelasticity. The content of the macromonomer is not particularly limited. The content of the macromonomer is preferably from 0.03 parts by mass to 5 parts by mass, and more preferably from 0.05 parts by mass to 1 part by mass, with respect to 100 parts by mass of the monovinyl monomer.

The content of the polymerizable monomer is appropriately adjusted so that the toner obtains the above-specified viscoelasticity. The content of the polymerizable monomer is not particularly limited. The content of the polymerizable monomer is preferably from 60 parts by to 95 parts by mass, more preferably from 65 parts by mass to 90 parts by mass, and still more preferably from 70 parts by mass to 85 parts by mass, with respect to 100 parts by mass of the total solid content contained in the polymerizable monomer composition.

In the present disclosure, a “solid content” means all components other than solvents, and liquid monomers and the like are included in the “solid content”.

As the colorant contained in the toner of the first present disclosure, a colorant conventionally used in toners can be appropriately selected and used. The colorant is not particularly limited. When producing a color toner, a black colorant, a cyan colorant, a yellow colorant or a magenta colorant can be used.

Examples of the black colorant include carbon black, titanium black and magnetic powder such as zinc-iron oxide and nickel-iron oxide.

Examples of the cyan colorant include cyan pigments such as phthalocyanine pigments (e.g., copper phthalocyanine pigments and derivatives thereof) and anthraquinone pigments, and cyan dyes. The specific examples include C.I. Pigment Blue 2, 3, 6, 15, 15:1, 15:2, 15:3, 15:4, 16, 17:1, 60; and C.I. Solvent Blue 70.

Examples of the yellow colorant include yellow pigments such as azo-based pigments (e.g., monoazo pigments and disazo pigments) and condensed polycyclic pigments, and yellow dyes. The specific examples include C.I. Pigment Yellow 3, 12, 13, 14, 15, 17, 62, 65, 73, 74, 83, 93, 97, 120, 138, 155, 180, 181, 185, 186, 213 and 214; and C.I. Solvent Yellow 98 and 162.

Examples of the magenta colorant include magenta pigments such as azo-based pigments (e.g., monoazo pigments and disazo pigments) and condensed polycyclic pigments (e.g., quinacridone pigments), and magenta dyes. The specific examples include C.I. Pigment Red 31, 48, 57:1, 58, 60, 63, 64, 68, 81, 83, 87, 88, 89, 90, 112, 114, 122, 123, 144, 146, 149, 150, 163, 170, 184, 185, 187, 202, 206, 207, 209, 237, 238, 251, 254, 255 and 269; C.I. Pigment Violet 19; C.I. Solvent Red 1, 3, 8, 23, 24, 25, 27, 30, 49, 81, 82, 83, 84, 100, 109, 121; C.I. Disperse Red 9; C.I. Solvent Violet 8, 13, 14, 21, 27; C.I. Disperse Violet 1; C.I. Basic Red 1, 2, 9, 12, 13, 14, 15, 17, 18, 22, 23, 24, 27, 29, 32, 34, 35, 36, 37, 38, 39, 40; and C.I. Basic Violet 1, 3, 7, 10, 14, 15, 21, 25, 26, 27, 28.

The colorants may be used alone or in combination of two or more thereof.

From the viewpoint that the toner having the desired CBD and flowability can be easily obtained, as the black colorant, carbon black is preferred. As the cyan colorant, a phthalocyanine pigment such as a copper phthalocyanine pigment and a derivative thereof is preferred, and particularly preferred is C.I. Pigment Blue 15:3. As the yellow colorant, an azo-based pigment such as a disazo pigment is preferred, and particularly preferred is C.I. Pigment Yellow 155. As the magenta colorant, a condensed polycyclic pigment such as a quinacridone pigment is preferred, and particularly preferred is C.I. Pigment Red 122.

The content of the colorant is preferably from 1 part by mass to 20 parts by mass, more preferably from 5 parts by mass to 15 parts by mass, and still more preferably from 7 parts by mass to 13 parts by mass, with respect to 100 parts by mass of the polymerizable monomer.

When the content of the colorant is within the above range, the toner having the desired CBD and flowability can be easily obtained.

The polymerizable monomer composition contains a softening agent. When the toner contains a softening agent, the releasability of the toner from the fixing roller at the time of toner fixing can be improved. The softening agent is not particularly limited as long as it is one that is generally used as a softening agent or a releasing agent for toners. As the softening agent, examples include low-molecular-weight polyolefin waxes and modified waxes thereof; petroleum waxes such as paraffin; mineral waxes such as ozokerite; synthetic waxes such as Fischer-Tropsch wax; and ester waxes such as dipentaerythritol ester and carnauba. Among them, from the viewpoint of improving the balance between the storage stability and low-temperature fixability of the toner by adjusting the viscoelasticity of the toner, ester waxes are preferred, synthetic ester waxes obtained by esterifying an alcohol and a carboxylic acid are more preferred, and polyfunctional ester waxes obtained by esterifying a polyhydric alcohol and a monocarboxylic acid are still more preferred.

For example, as the polyfunctional ester wax, at least one selected from the group consisting of pentaerythritol ester compounds, glycerin ester compounds and dipentaerythritol ester compounds is preferably used. As such a preferable polyfunctional ester wax, examples include, but are not limited to, pentaerythritol ester compounds such as pentaerythritol tetrapalmitate, pentaerythritol tetrabehenate and pentaerythritol tetrastearate; glycerin ester compounds such as hexaglycerin tetrabehenate tetrapalmitate, hexaglycerin octabehenate, pentaglycerin heptabehenate, tetraglycerin hexabehenate, triglycerin pentabehenate, diglycerin tetrabehenate and glycerin tribehenate; and dipentaerythritol ester compounds such as dipentaerythritol hexamyristate and dipentaerythritol hexapalmitate.

The weight average molecular weight Mw of the softening agent is not particularly limited. It is preferably within a range of from 400 to 3500, and more preferably from 500 to 3000.

The weight average molecular weight Mw of the softening agent can be measured by the same method as the method for measuring the weight average molecular weight Mw of the polymer described later. In the case of the ester wax, it is also possible to calculate the weight average molecular weight Mw by the following procedure. First, the ester wax is extracted with a solvent; the ester wax is decomposed into an alcohol and a carboxylic acid by hydrolysis; and by carrying out a composition analysis, the molecular weight of the ester wax can be calculated from the structural formula. The weight average molecular weight Mw of the ester wax has the same result as the molecular weight calculated from the structural formula.

From the viewpoint of improving the balance between the storage stability and low-temperature fixability of the toner by adjusting the viscoelasticity of the toner, the melting point of the softening agent is preferably within the range of from 50° C. to 90° C., more preferably within the range of from 60° C. to 85° C., and still more preferably within the range of from 70° C. to 80° C.

The content of the softening agent is not particularly limited. From the viewpoint of improving the balance between the storage stability and low-temperature fixability of the toner by adjusting the viscoelasticity of the toner, the content of the softening agent is preferably from 1 part by mass to 30 parts by mass, and more preferably from 5 parts by mass to 20 parts by mass, with respect to 100 parts by mass of the monovinyl monomer.

The softening agents may be used alone or in combination of two or more thereof.

The polymerizable monomer composition contains a positively- or negatively-chargeable charge control agent to improve chargeability of the toner.

The charge control agent is not particularly limited as long as it is one that is generally used as a charge control agent for toners. Among charge control agents, a positively- or negatively-chargeable charge control resin is preferred because it has high compatibility with a polymerizable monomer and can impart stable chargeability (charge stability) to the toner particles.

As the positively- or negatively-chargeable charge control resin, a functional group-containing copolymer can be used. As the positively-chargeable charge control resin, for example, a functional group-containing copolymer that contains a constitutional unit containing a functional group such as an amino group, a quaternary ammonium group and a quaternary ammonium salt-containing group, can be used. Examples of the functional group-containing copolymer include a polyamine resin, a quaternary ammonium group-containing copolymer and a quaternary ammonium salt group-containing copolymer. As the negatively-chargeable charge control resin, for example, a functional group-containing copolymer that contains a constitutional unit containing a functional group such as a sulfonic acid group, a sulfonate-containing group, a carboxylic acid group and a carboxylic acid salt-containing group, can be used. Examples of the functional group-containing copolymer include a sulfonic acid group-containing copolymer, a sulfonic acid salt group-containing copolymer, a carboxylic acid group-containing copolymer, and a carboxylic acid salt group-containing copolymer. These charge control resins may be used alone or in combination of two or more thereof.

From the viewpoint that the toner having the above-specified viscoelasticity can be easily obtained, in the functional group-containing copolymer that is used as a positively- or negatively-chargeable charge control resin, the content ratio of the functional group-containing constitutional unit is preferably 10% by mass or less, and more preferably 8% by mass or less. On the other hand, from the viewpoint of improving the charge stability and storage stability of the toner and suppressing the occurrence of spouting of the toner when enduring in a high temperature and high humidity environment, the content ratio of the functional group-containing constitutional unit in the functional group-containing copolymer is preferably 1.0% by mass or more, and more preferably 3.0% by mass or more. It is presumed that, when the charge control resin sufficiently contains the functional group, the charge control resin is likely to be localized near the surface of each colorant resin particle, and the charge control resin functions like the shell of the colored resin particles, thereby improving the storage stability of the toner and suppressing the occurrence of spouting of the toner when enduring in a high temperature and high humidity environment.

In the present disclosure, the percentage of the functional group-containing constitutional unit in the functional group-containing copolymer may be simply referred to as “functional group amount”.

As the functional group-containing copolymer that is used as a positively- or negatively-chargeable charge control resin, a styrene-acrylic resin is preferably used, since it has high compatibility with a polymerizable monomer and the toner having the above-specified viscoelasticity can be easily obtained. The styrene-acrylic copolymer may be a copolymer of a vinyl aromatic hydrocarbon monomer and a (meth)acrylate monomer.

The glass transition temperature (Tg) of the functional group-containing copolymer used as the positively- or negatively-chargeable charge control resin, is preferably within a range of from 50° C. to 110° C., and more preferably within a range of from 60° C. to 100° C. When the glass transition temperature (Tg) of the functional group-containing copolymer is within the above range, the toner having the above-specified viscoelasticity can be easily obtained, and the storage stability of the toner can be improved. It is presumed that, since the functional group-containing copolymer is likely to be localized near the surface of each colorant resin particle, and it functions like the shell of the colored resin particles, when the Ty of the functional group-containing copolymer is within the above range, the storage stability of the toner is improved due to the sufficiently high Tg.

The glass transition temperature (Tg) of the functional group-containing copolymer is measured by the same method as that of the glass transition temperature (Tg) of the toner described above.

The weight average molecular weight Mw of the functional group-containing copolymer that is used as a positively- or negatively-chargeable charge control resin, is preferably within a range of from 5000 to 30000, and more preferably within a range of from 10000 to 25000.

As the positively-chargeable charge control agent other than the positively-chargeable charge control resin, examples include a nigrosine dye, a quaternary ammonium salt, a triaminotriphenylmethane compound and an imidazole compound.

As the negatively-chargeable charge control agent other than the negatively-chargeable charge control resin, examples include an azo dye containing a metal such as Cr, Co, Al and Fe, a salicylic acid metal compound and an alkyl salicylic acid metal compound.

The charge control agents may be used alone or in combination of two or more thereof.

In the present disclosure, the charge control agent is used in an amount of generally from 0.1 parts by mass to 10 parts by mass, preferably from 0.3 parts by mass to 5 parts by mass, and more preferably from 0.6 parts by mass to 1.5 parts by mass, with respect to 100 parts by mass of the monovinyl monomer.

When the content of the charge control agent is equal to or more than the lower limit value, the occurrence of fog can be suppressed. On the other hand, when the content of the charge control agent is equal to or less than the upper limit value, printing stains can be suppressed. As the content of the charge control agent increases, the CBD of the toner is likely to increase, and the flowability is likely to be higher. When the content of the charge control agent is within the above range, the toner having the desired CBD and flowability can be easily obtained.

It is preferable that the polymerizable monomer composition further contains a molecular weight modifier.

The molecular weight modifier is not particularly limited, as long as it is one that is generally used as a molecular weight modifier for toners. As the molecular weight modifier, examples include, but are not limited to, mercaptans such as t-dodecyl mercaptan, n-dodecyl mercaptan, n-octyl mercaptan and 2,2,4,6,6-pentamethylheptane-4-thiol; and thiuram disulfides such as tetramethyl thiuram disulfide, tetraethyl thiuram disulfide, tetrabutyl thiuram disulfide, N,N′-dimethyl-N, N′-diphenyl thiuram disulfide and N,N′-dioctadecyl-N, N′-diisopropyl thiuram disulfide. The molecular weight modifiers may be used alone or in combination of two or more thereof.

In the present disclosure, from the viewpoint that the toner having the above-specified viscoelasticity can be easily obtained, it is preferable that the content of the molecular weight modifier is adjusted so that the weight average molecular weight Mw of the polymer contained in the binder resin falls within the preferable range described later.

The molecular weight modifier is used in an amount of preferably from 1.0 part by mass to 3.0 parts by mass, and more preferably from 1.1 parts by mass to 2.0 parts by mass, with respect to 100 parts by mass of the monovinyl monomer.

As the content of the molecular weight modifier increases, the weight average molecular weight of the polymer contained in the binder resin is likely to decrease. The molecular weight modifier is likely to present on the surface of the colored resin particles. As the content of the molecular weight modifier increases, the CBD of the toner is likely to decrease, and the flowability is likely to decrease. When the content of the molecular weight modifier is within the above range, the toner having the desired CBD and flowability can be easily obtained.

### (A-2) Suspension Step (Droplet Forming Step) to Obtain Suspension

Then, the polymerizable monomer composition is dispersed in an aqueous medium containing a dispersion stabilizer, and after adding a polymerization initiator, droplet formation of the polymerizable monomer composition is performed. The polymerization initiator may be added before the droplet formation after the polymerizable monomer composition is dispersed in an aqueous medium, as described above. However, the polymerization initiator may be added to the polymerizable monomer composition before being dispersed in an aqueous medium.

The method of forming the droplets is not particularly limited. For example, the method is performed using a device capable of strong agitation, such as an (in-line type) emulsifying and dispersing machine (product name: MILDER, manufactured by: Pacific Machinery & Engineering Co., Ltd.) and a high-speed emulsifying and dispersing machine (product name: T. K. HOMOMIXER MARK II type, manufactured by: PRIMIX Corporation).

Examples of the polymerization initiator include, but are not limited to, persulfates such as potassium persulfate and ammonium persulfate; azo compounds such as 4,4′-azobis(4-cyanovaleric acid), 2,2′-azobis(2-methyl-N-(2-hydroxyethyl) propionamide), 2,2′-azobis(2-amidinopropane) dihydrochloride, 2,2′-azobis(2,4-dimethylvaleronitrile) and 2,2′-azobisisobutyronitrile; and organic peroxides such as di-t-butylperoxide, benzoylperoxide, t-butylperoxy-2-ethylhexanoate, t-butylperoxy-2-ethylbutanoate, t-hexylperoxy-2-ethylbutanoate, diisopropylperoxydicarbonate, di-t-butylperoxyisophthalate and t-butylperoxyisobutyrate. Among them, an organic peroxide is preferably used because the residual polymerizable monomer can be reduced, and the printing durability of the toner becomes excellent. From the view point that the initiator efficiency is high and the residual polymerizable monomer can be reduced, among the organic peroxides, peroxy esters are preferred, and non-aromatic peroxy esters, that is, peroxy esters having no aromatic ring, are more preferred.

These polymerization initiators may be used alone or in combination of two or more thereof.

The amount of the polymerization initiator to be added, which is used in the polymerization reaction of the polymerizable monomer composition, is preferably from 0.1 parts by mass to 20 parts by mass, more preferably from 0.3 parts by mass to 15 parts by mass, and particularly preferably from 1 part by mass to 10 parts by mass, with respect to 100 parts by mass of the monovinyl monomer.

In the present disclosure, an aqueous medium is a medium containing water as a main component.

In the present disclosure, it is preferable that a dispersion stabilizer is contained in the aqueous medium. As the dispersion stabilizer, examples include the following inorganic and organic compounds: inorganic compounds including sulfates such as barium sulfate and calcium sulfate, carbonates such as barium carbonate, calcium carbonate and magnesium carbonate, phosphates such as calcium phosphate, metal oxides such as aluminum oxide and titanium oxide, and metal hydroxides such as aluminum hydroxide, magnesium hydroxide and iron (II) hydroxide, and organic compounds including water-soluble polymers such as polyvinyl alcohol, methyl cellulose and gelatin; anionic surfactants, nonionic surfactants, and ampholytic surfactants. These dispersion stabilizers may be used alone or in combination of two or more thereof.

Among the dispersion stabilizers, the inorganic compounds are preferred. As the aqueous solvent containing the dispersion stabilizer, a colloid of a sparingly water-soluble metal hydroxide is particularly preferred. The use of the inorganic compounds, particularly the use of the colloid of the sparingly water-soluble metal hydroxide, can narrow the particle size distribution of the colored resin particles and can reduce the amount of the dispersion stabilizer remaining after washing. Accordingly, the polymerized toner thus obtained becomes capable of reproducing clear images and inhibiting a deterioration in environmental stability.

The sparingly water-soluble metal hydroxide colloid can be prepared by, for example, reacting a water-soluble polyvalent metal salt (excluding an alkaline earth metal hydroxide salt) and at least one selected from an alkali metal hydroxide salt and an alkaline earth metal hydroxide salt in the aqueous medium.

As the alkali metal hydroxide salt, examples include, but are not limited to, lithium hydroxide, sodium hydroxide and potassium hydroxide. As the alkaline earth metal hydroxide salt, examples include, but are not limited to, barium hydroxide and calcium hydroxide.

The water-soluble polyvalent metal salt may be a water-soluble polyvalent metal salt other than compounds corresponding to alkaline earth metal hydroxide salts. As the water-soluble polyvalent metal salt, examples include, but are not limited to, a magnesium metal salt such as magnesium chloride, magnesium phosphate and magnesium sulfate; a calcium metal salt such as calcium chloride, calcium nitrate, calcium acetate and calcium sulfate; an aluminum metal salt such as aluminum chloride and aluminum sulfate; a barium salt such as barium chloride, barium nitrate and barium acetate; and a zinc salt such as zinc chloride, zinc nitrate and zinc acetate. Among them, a magnesium metal salt, a calcium metal salt and an aluminum metal salt are preferred; a magnesium metal salt is more preferred; and magnesium chloride is particularly preferred. These water-soluble polyvalent metal salts may be used alone or in combination of two or more.

As the method for reacting the water-soluble polyvalent metal salt and at least one selected from the alkali metal hydroxide salt and the alkaline earth metal hydroxide salt in the aqueous medium, examples include, but are not limited to, a method in which an aqueous solution of the water-soluble polyvalent metal salt and an aqueous solution of at least one selected from the alkali metal hydroxide salt and the alkaline earth metal hydroxide salt are mixed together.

The content of the dispersion stabilizer is appropriately adjusted so that the toner having the desired particle diameter is obtained, and it is not particularly limited. With respect to 100 parts by mass of the polymerizable monomer in the polymerizable monomer composition, the content of the dispersion stabilizer is preferably from 0.5 parts by mass to 10 parts by mass, and more preferably from 1.0 part by mass to 8.0 parts by mass. When the content of the dispersion stabilizer is equal to or more than the lower limit value, the droplets of the polymerizable monomer composition can be sufficiently dispersed in the suspension so that they do not join together. On the other hand, when the content of the dispersion stabilizer is equal to or less than the upper limit value, an increase in the viscosity of the suspension can be prevented during the droplet formation, and a failure such as clogging of a granulator with the suspension can be avoided.

Also, the content of the dispersion stabilizer is generally from 1 part by mass to 15 parts by mass, and preferably from 1 part by mass to 8 parts by mass, with respect to 100 parts by mass of the aqueous medium.

### (A-3) Polymerization Step

After the droplet formation of the polymerizable monomer composition as described above in (A-2), the polymerizable monomer composition is subjected to a polymerization reaction in the presence of a polymerization initiator to form colored resin particles. In other words, an aqueous dispersion in which droplets of the polymerizable monomer composition are dispersed, is heated to initiate polymerization, thereby forming an aqueous dispersion of colored resin particles.

The condition of the heating is preferably adjusted such that the weight average molecular weight Mw of the polymer of the polymerizable monomer falls within the preferable range described later. The condition of the heating is not particularly limited. The heating temperature is preferably 50° C. or higher, and more preferably from 60° C. to 95° C. The heating time is preferably from 1 hour to 20 hours, and more preferably from 2 hours to 15 hours.

In the present disclosure, the colorant resin particles obtained by the polymerization step, on which an external additive is added, may be used as the toner of the first present disclosure. It is preferable to use the colored resin particles obtained by the polymerization step as the core layer of colored resin particles of a so-called core-shell type (or also referred to as “capsule type”). The core-shell type colored resin particles have a structure in which the outside of the core layer is coated with a shell layer formed of a material different from the core layer. By coating the core layer made of a material having a low softening point with a material having a softening point higher than that, the toner can easily obtain the above-specified viscoelasticity, and the low-temperature fixability and storage stability of the toner can be improved in a well-balanced manner.

The method for producing the core-shell type colored resin particles by using the colored resin particles obtained by the polymerization step, is not particularly limited. The core-shell type colored resin particles can be produced by any conventional method. The in situ polymerization method and the phase separation method are preferable from the viewpoint of production efficiency.

A method for producing the core-shell type colored resin particles by the in situ polymerization method will be described below.

A polymerizable monomer for forming a shell layer (a polymerizable monomer for shell) and a polymerization initiator are added to an aqueous medium in which the colorant resin particles obtained by the polymerization step are dispersed, and the mixture is polymerized, thereby obtaining the core-shell type colored resin particles.

As the polymerizable monomer for shell, the same polymerizable monomers as the polymerizable monomers described above can be used. Among them, those that can be a polymer having a Tg of more than 80° C., such as styrene, acrylonitrile and methyl methacrylate, are preferably used alone or in combination of two or more thereof.

As the polymerization initiator used for the polymerization of the polymerizable monomer for shell, examples include, but are not limited to, water-soluble polymerization initiators including metal persulfates such as potassium persulfate and ammonium persulfate, and azo-type initiators such as 2,2′-azobis(2-methyl-N-(2-hydroxyethyl) propionamide) and 2,2′-azobis(2-methyl-N-(1,1-bis(hydroxymethyl)-2-hydroxyethyl) propionamide). These polymerization initiators may be used alone or in combination of two or more thereof. The content of the polymerization initiator is preferably from 0.1 parts by mass to 30 parts by mass, and more preferably from 1 part by mass to 20 parts by mass, with respect to 100 parts by mass of the polymerizable monomer for shell.

The polymerization temperature of the shell layer is preferably 50° C. or higher, and more preferably from 60° C. to 95° C. The polymerization reaction time is preferably from 1 hour to 20 hours, and more preferably from 2 hours to 15 hours.

### (A-4) Washing, Filtrating and Dehydrating Step

It is preferable that, after completion of the polymerization, the operation of filtration, washing for removal of the dispersion stabilizer, and dehydration is repeatedly preformed several times as necessary on the aqueous dispersion of the colored resin particles obtained by the polymerization, according to a conventional method.

As the method of the washing, when an inorganic compound is used as the dispersion stabilizer, it is preferable to dissolve the dispersion stabilizer in water, by addition of an acid or an alkali to an aqueous dispersion of the colored resin particles, and then remove the dissolved dispersion stabilizer from the water. When a colloid of a hardly water-soluble inorganic hydroxide is used as the dispersion stabilizer, it is preferable to add an acid to adjust the pH of the colored resin particle aqueous dispersion to 6.5 or less. As the acid to be added, inorganic acids such as sulfuric acid, hydrochloric acid and nitric acid, and organic acids such as formic acid and acetic acid can be used, and sulfuric acid is particularly preferred because of the high removal efficiency and small burden on the production facilities.

The dehydrating and filtering may be carried out by any of various known methods. The method of the dehydrating and filtering is not particularly limited. For example, a centrifugal filtration method, a vacuum filtration method and a pressure filtration method may be used.

As needed, drying may be carried out after the dehydration. The drying may be carried out by any of various methods. The method of the drying is not particularly limited.

### (B) Pulverization Method

In the case of producing the colored resin particles by employing the pulverization method, the production is carried out by the following steps, for example.

First, a binder resin, a colorant, a softening agent, a charge control agent, and other additives which are added as needed are mixed by means of a mixer such as a ball mill, a V type mixer, FM MIXER (product name, manufactured by: Nippon Coke & Engineering Co., Ltd.), a high-speed dissolver, an internal mixer and a fallberg. Next, the thus-obtained mixture is kneaded while heating by means of a press kneader, a twin screw kneading machine, a roller or the like. The thus-obtained kneaded product is coarsely pulverized by means of a pulverizer such as a hammer mill, a cutter mill and a roller mill. The coarsely pulverized product is finely pulverized by means of a pulverizer such as a jet mill and a high-speed rotary pulverizer. Then, the finely pulverized product is classified into desired particle diameters by means of a classifier such as an air classifier and an airflow classifier, thereby obtaining the colored resin particles produced by the pulverization method.

As the binder resin, the colorant, the softening agent and the charge control agent used in the pulverization method, those mentioned above in “(A) Suspension Polymerization Method” can be used. The colored resin particles obtained by the pulverization method can also be used to produce core-shell type colored resin particles by using an in situ polymerization method or the like, in the same way as the colored resin particles obtained by the above-mentioned “(A) Suspension Polymerization Method”.

As the binder resin, in addition to the binder resin described above, resins which have been widely used for toners conventionally can be used. Examples of the binder resin used in the pulverization method include polystyrene, a styrene-butyl acrylate copolymer, a polyester-based resin, and an epoxy-based resin.

### I-3. Colored Resin Particles

The colored resin particles are obtained by the production method such as the above-mentioned “(A) Suspension polymerization Method” and “(B) Pulverization Method”.

Hereinafter, the colored resin particles contained in the toner of the first present disclosure will be described. The colored resin particles described below include both core-shell type colored resin particles and colored resin particles which are not core-shell type.

The colored resin particles used in the first present disclosure contain the binder resin, the colorant, the softening agent and the charge control agent, and it may further contain other additives if necessary.

Examples of the binder resin contained in the colored resin particles include the polymer obtained by polymerizing the polymerizable monomer mentioned above in “(A) Suspension Polymerization Method”. In the present disclosure, a polymer may be either a homopolymer or a copolymer. Preferable polymerizable monomers which derive the constitutional units of the polymer are the same as the preferred polymerizable monomers described above in “(A) Suspension Polymerization Method”. From the viewpoint that the toner can easily obtain the above-specified viscoelasticity and that the low-temperature fixability and storage stability of the toner can be improved in a well-balanced manner, it is preferable that the binder resin, which is contained in the colored resin particles, contains a polymer of one or two or more kinds of polymerizable monomers containing at least one kind of monovinyl monomer selected from the group consisting of styrene, acrylic esters and methacrylic esters. It is more preferable that the binder resin contains a polymer of one or two or more kinds of polymerizable monomers containing styrene and at least one selected from the group consisting of acrylic esters and methacrylic esters.

The structure of each constitutional unit and the amount of each constitutional unit in all the constitutional units of the polymer can be determined from the charge amount thereof at the time of synthesizing the polymer, or they can be calculated from integrated values obtained by H-NMR measurement.

The weight average molecular weight Mw of the polymer contained in the binder resin is preferably 4.40×10⁵ or more and 7.00×10⁵ or less, from the viewpoint that the toner having the above-specified viscoelasticity can be easily obtained, and that the low-temperature fixability and storage stability of the toner are improved in a well-balanced manner. Moreover, from the viewpoint of improving the storage stability of the toner, the lower limit of the weight average molecular weight Mw is more preferably 4.50×10⁵ or more, and still more preferably 4.60×10⁵ or more. On the other hand, from the viewpoint of improving the low-temperature fixability of the toner, the upper limit of the weight average molecular weight Mw is more preferably 6.50×10⁵ or less, and still more preferably 6.00×10⁵ or less. The polymer contained in the binder resin is typically a polymer of the above-mentioned polymerizable monomer.

As the weight average molecular weight Mw of the polymer decreases, the glass transition temperature (Tg) of the toner, which is specified from the temperature-tan δ curve at a measurement frequency of 24 Hz, is likely to decreases; moreover, the area of the trapezoid is likely to increase. When the weight average molecular weight Mw of the polymer is within the range, the toner having the above-specified viscoelasticity can be easily obtained.

In the present disclosure, the weight average molecular weight Mw of the polymer can be determined as a polystyrene equivalent molecular weight measured by GPC. As a measurement sample, a sample obtained by dissolving a polymer to be measured in tetrahydrofuran (THE) is generally used. When the weight average molecular weight Mw of the polymer contained in the binder resin in the toner is measured, the toner is dissolved in tetrahydro tetrahydrofuran (THF) and used as the measurement sample, and from the measurement result, the weight average molecular weight Mw of the polymer contained as the binder resin can be determined using data obtained by subtracting a peak previously measured for a polymer other than the polymer contained as the binder resin, that is, a charge control resin, a softening agent, and the like.

The binder resin contained in the colored resin particles is typically a polymer of the polymerizable monomer. A small amount of a polyester-based resin, an epoxy-based resin or the like, which are conventionally widely used as a binder resin in toners, or an unreacted polymerizable monomer may be contained to the extent that the toner obtains the above-specified viscoelasticity. The content of the polyester-based resin contained in 100 parts by mass of the binder resin is preferably 5 parts by mass or less, more preferably 1 part by mass or less, and still more preferably 0.1 parts by mass or less. It is particularly preferable that the binder resin does not contain a polyester-based resin. When the content of the polyester-based resin is equal to or lower than the above upper limit value, the environmental stability of the toner can be improved, and in particular, a change in the charging of the toner due to a change in humidity can be suppressed.

In addition, when the binder resin contains a resin other than the polymer of the polymerizable monomer, the content of the polymer of the polymerizable monomer in 100 parts by mass of the binder resin is preferably 95 parts by mass or more, more preferably 97 parts by mass or more, and still more preferably 99 parts by mass or more, from the viewpoint that the toner having the above-specified viscoelasticity can be easily obtained.

From the viewpoint that the toner having the above-specified viscoelasticity can be easily obtained, the total content of the binder resin is preferably from 70 parts by mass to 99 parts by mass, more preferably from 75 parts by mass to 97 parts by mass, and still more preferably from 80 parts by mass to 95 parts by mass, with respect to 100 parts by mass of the total solid content contained in the colored resin particles.

The colorant, the softening agent and the charge control agent contained in the colored resin particles are the same as those described above in “(A) Suspension Polymerization Method”.

The content of the colorant contained in the colored resin particles is appropriately adjusted according to the type of the colorant so that the desired color development is obtained and the toner obtains the above-specified viscoelasticity. The content of the colorant is not particularly limited. The content of the colorant is preferably from 1 part by mass to 20 parts by mass, more preferably from 5 parts by mass to 15 parts by mass, and still more preferably from 7 parts by mass to 13 parts by mass, with respect to 100 parts by mass of the binder resin.

The content of the softening agent contained in the colored resin particles is preferably from 1 part by mass to 30 parts by mass, and more preferably from 5 parts by mass to 20 parts by mass, with respect to 100 parts by mass of the binder resin, from the viewpoint of improving the balance between the storage stability and low-temperature fixability of the toner.

The content of the charge control agent contained in the colored resin particles is preferably from 0.1 parts by mass to 10 parts by mass, more preferably from 0.3 parts by mass to 5 parts by mass, and still more preferably from 0.6 parts by mass to 1.5 parts by mass, with respect to 100 parts by mass of the binder resin. When the content of the charge control agent is equal to or more than the lower limit value, the occurrence of fog can be suppressed. When the content is equal to or less than the upper limit value, printing stains can be suppressed. When the content of the charge control agent is within the above range, the toner having the desired CBD and flowability can be easily obtained.

The volume average particle diameter (Dv) of the colored resin particles is preferably from 3 μm to 15 μm, and more preferably from 4 μm to 12 μm. When the Dv of the colored resin particles is equal to or more than the lower limit value, the flowability of the toner can be improved; a deterioration in the transfer property of the toner and a decrease in image density can be suppressed; and the occurrence of spouting of the toner when enduring in a high temperature and high humidity environment can be suppressed. On the other hand, when the Dv of the colored resin particles is equal to or less than the upper limit value, a decrease in image resolution can be suppressed. When the Dv of the colored resin particles is within the above range, the toner having the desired CBD and flowability can be easily obtained.

The colored resin particles preferably have a ratio (Dv/Dn) of the volume average particle diameter (Dv) to the number average particle diameter (Dn) of from 1.0 to 1.3, and more preferably from 1.0 to 1.2. When the Dv/Dn of the colored resin particles is 1.3 or less, it is possible to suppress a deterioration in the transfer property of the toner and a decrease in image density and image resolution. In addition, when the Dv/Dn of the colored resin particles is 1.3 or less, the toner having the desired CBD and flowability can be easily obtained. The volume average particle diameter and number average particle diameter of the colored resin particles can be measured using a particle size analyzer (product name: MULTISIZER; manufactured by: Beckman Coulter, Inc.) or the like.

The average circularity of the colored resin particles is preferably from 0.96 to 1.00, more preferably from 0.97 to 1.00, and still more preferably from 0.98 to 1.00, from the viewpoint of image reproducibility.

When the average circularity of the colored resin particles is 0.96 or more, fine line reproducibility of printing can be improved. In addition, when the average circularity of the colored resin particles is 0.96 or more, the toner having the desired CBD and flowability can be easily obtained. The average circularity of the colored resin particles of the present disclosure is 1 or less. When the measurement sample of the colored resin particles is perfectly spherical, the average circularity is 1.

In the present disclosure, the “circularity” is defined as a value obtained by dividing the perimeter of the circle having the same area as the projected area of the particle image by the perimeter of the projected image of the particle. The average circularity is an index that shows the degree of the surface roughness of the colored resin particles, and it can be used as a simple method for quantitatively representing the shape of the particles. The average circularity becomes smaller, as the surface shape of the measurement sample becomes more complex.

For example, the circularity of the colored resin particles can be determined as follows. An aqueous solution in which the colored resin particles are dispersed, is used as a sample solution, and the projected image of the colored resin particles in the sample solution is taken by means of a flow type particle image analyzer (e.g., product name: FPIA-2100, manufactured by: Sysmex Corporation). The perimeter of the circle having the same area as the projected area of the particle image, and the perimeter of the projected particle image are measured from the projected image, and the circularity of the colored resin particles is obtained by the following calculation formula 1: (Circularity)=(Perimeter of the circle having the same area as the projected area of the particle image)/(Perimeter of the projected particle image). The average circularity is the average value of the circularities of the colored resin particles contained in the sample solution.

### I-4. Toner of the First Present Disclosure

The toner of the first present disclosure contains the above-described colored resin particles and the external additive. As the external addition treatment, the colored resin particles are mixed and stirred with the external additive to add the external additive on the surface of the colored resin particles, thereby obtaining a one-component toner (developer). The one-component toner may be mixed and stirred with carrier particles to obtain a two-component developer.

In the first present disclosure, as the external additive, the toner preferably contains inorganic fine particles A having a number average primary particle diameter of from 36 nm to 100 nm.

When the number average primary particle diameter of the inorganic fine particles A is less than 36 nm, the CBD value may become too large, and an adverse effect on printing performance (e.g., fog) may occur due to a decrease in spacer effect thereof. On the other hand, when the number average primary particle diameter of the inorganic fine particles A is more than 100 nm, the CBD value may become too small or the flowability may decrease, and an adverse effect on printing performance may occur, since the inorganic fine particles A are likely to be released from the surface of the toner particles, so that the function of the inorganic fine particles A as the external additive decreases.

The lower limit of the number average primary particle diameter of the inorganic fine particles A is more preferably 40 nm or more, and still more preferably from 45 nm. On the other hand, the upper limit is more preferably 80 nm or less, and still more preferably 70 nm or less. Also, the inorganic fine particles A are preferably hydrophobized particles.

In the present disclosure, for example, a silane coupling agent, silicone oil, fatty acid, fatty acid metal salt or the like can be used as the hydrophobizing agent. Among them, a silane coupling agent and silicone oil are preferred.

The lower limit of the content of the inorganic fine particles A is preferably 0.30 parts by mass or more, more preferably 0.50 parts by mass or more, and still more preferably 1.00 part by mass or more, with respect to 100 parts by mass of the binder resin in the colored resin particles. On the other hand, the upper limit is preferably 2.50 parts by mass or less, more preferably 2.00 parts by mass or less, and still more preferably 1.50 parts by mass or less, with respect to 100 parts by mass of the binder resin in the colored resin particles.

When the content of the inorganic fine particles A is equal to or more than the lower limit value, the inorganic fine particles A can sufficiently function as the external additive. Accordingly, a deterioration in printing performance or storage stability is suppressed. On the other hand, when the content of the inorganic fine particles A is equal to or less than the upper limit value, the release of the inorganic fine particles A from the surface of the toner particles is suppressed. Accordingly, a deterioration in printing performance is suppressed. When the content of the inorganic fine particles A is within the above range, the toner having the desired CBD and flowability can be easily obtained.

In the first present disclosure, as the external additive, the toner preferably contains inorganic fine particles B having a number average primary particle diameter of from 15 nm to 35 nm.

When the number average primary particle diameter of the inorganic fine particles B is less than 15 nm, the following problems may occur: since the inorganic fine particles B easily penetrate from the surface of the colored resin particles to the inside of the colored resin particles, the CBD value may become too large, and since sufficient flowability cannot be imparted to the toner particles, an adverse effect may be imposed on printing performance. On the other hand, when the number average primary particle diameter of the inorganic fine particles B is more than 35 nm, the following problems may occur: the CBD value may become too small, and sufficient flowability may not be imparted to the toner particles due to a decrease in the proportion of the inorganic fine particles B to the surface of the toner particles (the surface coverage).

The lower limit of the number average primary particle diameter of the inorganic fine particles B is more preferably 17 nm or more, and still more preferably 20 nm or more. On the other hand, the upper limit is more preferably 30 nm or less, and still more preferably 25 nm or less. Also, the inorganic fine particles B are preferably hydrophobized particles.

The lower limit of the content of the inorganic fine particles B is preferably 0.10 parts by mass or more, more preferably 0.30 parts by mass or more, and still more preferably 0.50 parts by mass or more, with respect to 100 parts by mass of the binder resin in the colored resin particles. On the other hand, the upper limit is preferably 2.00 parts by mass or less, more preferably 1.50 parts by mass or less, and still more preferably 1.00 part by mass or less, with respect to 100 parts by mass of the binder resin in the colored resin particles.

When the content of the inorganic fine particles B is equal to or more than the lower limit value, the inorganic fine particles B can sufficiently function as the external additive. Accordingly, a decrease in flowability is suppressed, and a deterioration in storage stability or durability is suppressed. On the other hand, when the content of the inorganic fine particles B is equal to or less than the upper limit value, the release of the inorganic fine particles B from the surface of the toner particles is suppressed. Accordingly, a deterioration in charge property is suppressed, thereby suppressing the occurrence of fog. When the content of the inorganic fine particles B is within the above range, the toner having the desired CBD and flowability can be easily obtained.

In the first present disclosure, as the external additive, the toner preferably contains inorganic fine particles C having a number average primary particle diameter of from 6 nm to 14 nm.

When the number average primary particle diameter of the inorganic fine particles C is less than 6 nm, the following problems may occur: since the inorganic fine particles C easily penetrate from the surface of the colored resin particles to the inside of the colored resin particles, the CBD value may become too large, and since sufficient flowability cannot be imparted to the toner particles, an adverse effect may be imposed on printing performance. On the other hand, when the number average primary particle diameter of the inorganic fine particles C is more than 14 nm, the following problems may occur: the CBD value may become too small, and in addition, sufficient flowability may not be imparted to the toner particles due to a decrease in the proportion of the inorganic fine particles C to the surface of the toner particles (the surface coverage).

The lower limit of the number average primary particle diameter of the inorganic fine particles C is more preferably 6.5 nm or more, and still more preferably 7.0 nm or more. On the other hand, the upper limit is more preferably 12 nm or less, and still more preferably 10 nm or less. Also, the inorganic fine particles C are preferably hydrophobized particles.

The lower limit of the content of the inorganic fine particles C is preferably 0.10 parts by mass or more, more preferably 0.15 parts by mass or more, and still more preferably 0.20 parts by mass or more, with respect to 100 parts by mass of the binder resin in the colored resin particles. On the other hand, the upper limit is preferably 1.50 parts by mass or less, more preferably 1.00 part by mass or less, still more preferably 0.80 parts by mass or less, and even more preferably 0.60 parts by mass or less, with respect to 100 parts by mass of the binder resin in the colored resin particles.

When the content of the inorganic fine particles C is equal to or more than the lower limit value, the inorganic fine particles C can sufficiently function as the external additive. Accordingly, a decrease in flowability is suppressed, and a deterioration in storage stability is suppressed. On the other hand, when the content of the inorganic fine particles C is equal to or less than the upper limit value, the release of the inorganic fine particles C from the surface of the toner particles is suppressed. Accordingly, a deterioration in charge property is suppressed, thereby suppressing the occurrence of fog. When the content of the inorganic fine particles C is within the above range, the toner having the desired CBD and flowability can be easily obtained.

The toner of the first present disclosure preferably contains any one of the inorganic fine particles A to C, more preferably contains any two of them, and still more preferably contains all of them. By appropriately controlling the particle diameter and amount of the inorganic fine particles A to C to be added, the viscoelasticity, CBD and flowability of the toner can be controlled.

As the inorganic fine particles A to C, examples include, but are not limited to, silica, titanium oxide, aluminum oxide, zinc oxide, tin oxide, calcium carbonate, calcium phosphate and cerium oxide. The inorganic fine particles A to C may be composed of different materials. However, it is preferable that they are composed of the same material. It is preferable that all of the inorganic fine particles A to C contain at least one selected from silica and titanium oxide, and it is more preferable that all of the inorganic fine particles A to C are composed of silica.

Various kinds of commercially-available silica fine particles can be used as the inorganic fine particles A, such as VPNA50H (product name, manufactured by: Nippon Aerosil Co., Ltd., number average primary particle diameter: 40 nm) and H05TA (product name, manufactured by: Clariant Corporation, number average primary particle diameter: 50 nm).

Various kinds of commercially-available silica fine particles can be used as the inorganic fine particles B, such as NA50Y (product name, manufactured by: Nippon Aerosil Co., Ltd., number average primary particle diameter: 35 nm), MSP-012 (product name, manufactured by: Tayca Corporation, number average primary particle diameter: 16 nm) and TG-7120 (product name, manufactured by: Cabot Corporation, number average primary particle diameter: 20 nm).

Various kinds of commercially-available silica fine particles can be used as the inorganic fine particles C, such as HDK2150 (product name, manufactured by: Clariant Corporation, number average primary particle diameter: 12 nm), R504 (product name, manufactured by: Nippon Aerosil Co., Ltd., number average primary particle diameter: 12 nm), RA200HS (product name, manufactured by: Nippon Aerosil Co., Ltd., number average primary particle diameter: 12 nm), MSP-013 (product name, manufactured by: Tayca Corporation, number average primary particle diameter: 12 nm) and TG-820F (product name, manufactured by: Cabot Corporation, number average primary particle diameter: 7 nm).

In the present disclosure, as the external additive, the toner preferably further contains organic fine particles D having a number average primary particle diameter of 1.0 μm or less. Accordingly, the toner having the desired CBD and flowability can be easily obtained.

When the toner contains the organic fine particles D as the external additive, filming on a photoconductor is less likely to occur, and the toner particles are provided with stable charge property over time, so that such a toner is obtained, that deterioration in image quality (e.g., fog) is less likely to occur even after continuous printing is carried out on many sheets, and a deterioration in image quality is less likely to occur especially even under a high temperature and high humidity environment (HH environment).

From the point of view that these effects can be easily exerted by the organic fine particles D, the lower limit of the number average primary particle diameter of the organic fine particles D is preferably 0.3 μm or more, more preferably 0.4 μm or more, and still more preferably 0.5 μm or more. On the other hand, the upper limit is more preferably 0.9 μm or less, and still more preferably 0.8 μm or less.

The lower limit of the content of the organic fine particles D is preferably 0.01 parts by mass or more, more preferably 0.02 parts by mass or more, still more preferably 0.03 parts by mass or more, and even more preferably 0.04 parts by mass or more, with respect to 100 parts by mass of the binder resin in the colored resin particles. On the other hand, the upper limit is preferably 0.19 parts by mass or less, more preferably 0.17 parts by mass or less, still more preferably 0.15 parts by mass or less, and even more preferably 0.13 parts by mass or less, with respect to 100 parts by mass of the binder resin in the colored resin particles.

When the content of the organic fine particles D is equal to or more than the lower limit value, the aggregation of the toner can be easily suppressed, and the occurrence of spouting of the toner is suppressed, accordingly. In addition, when the content of the organic fine particles D is equal to or more than the lower limit value, the organic fine particles D can sufficiently function as the external additive. Accordingly, a reduction in charge property in a high temperature and high humidity environment is suppressed, and the occurrence of fog can be suppressed. On the other hand, when the content of the organic fine particles D is equal to or less than the upper limit value, a deterioration in the fixability of the toner, which is due to the large external additive amount, can be suppressed. In addition, when the content of the organic fine particles D is equal to or less than the upper limit value, the release of the organic fine particles D from the surface of the toner particles is suppressed, and a decrease in flowability is suppressed, accordingly.

When the content of the organic fine particles D is within the above range, the toner having the desired CBD and flowability can be easily obtained.

As the organic fine particles D, fatty acid metal salt particles are preferably used. By using the fatty acid metal salt particles as the organic fine particles D, the CBD of the toner can easily fall within the above range.

The fatty acid (R—COOH) that serves to derive the fatty acid moiety (R—COO⁻) of the fatty acid metal salt particles may be a monocarboxylic acid containing only one carboxyl group (—COOH), and it is preferably a monocarboxylic acid having a chain structure, more preferably a saturated monocarboxylic acid having a chain structure, and still more preferably a linear saturated monocarboxylic acid.

Also, the fatty acid moiety (R—COO⁻) of the fatty acid metal salt particles is preferably one derived from a higher fatty acid in which the alkyl group (R—) has many carbon atoms. The number of the carbon atoms of the alkyl group in the fatty acid moiety is not particularly limited. It is preferably from 12 to 24, more preferably from 14 to 22, and still more preferably from 16 to 20.

As the higher fatty acid that is preferably used as a raw material for the fatty acid metal salt particles, examples include, but are not limited to, lauric acid (CH₃(CH₂)₁₀COOH), tridecanoic acid (CH₃(CH₂)₁₁COOH), myristic acid (CH₃(CH₂) 12COOH), pentadecanoic acid (CH₃(CH₂)₁₃COOH), palmitic acid (CH₃(CH₂)₄COOH), heptadecanoic acid (CH₃(CH₂)₁₅COOH), stearic acid (CH₃(CH₂)₁₆COOH), arachidic acid (CH₃(CH₂)₁₈COOH), behenic acid (CH₃(CH₂)₂₀COOH) and lignoceric acid (CH; (CH₂)₂₂COOH). Of them, stearic acid and behenic acid are preferred, and stearic acid is more preferred.

These fatty acids that are preferably used as a raw material for the fatty acid metal salt particles, may be used alone or in combination of two or more kinds. From the viewpoint of obtaining a uniform toner property, any one kind of the fatty acids is preferably used alone.

The metal contained in the fatty acid metal salt particles may be an alkaline metal, an alkaline-earth metal or a metal element of the Group 12 of the periodic table, such as Li, Na, K, Rb, Cs, Be, Mg, Ca, Sr, Ba and Zn. Of them, an alkaline-earth metal or a metal element of the Group 12 of the periodic table is preferred; at least one selected from Mg and Zn is more preferred; and Zn is still more preferred.

As the fatty acid metal salt particles, various kinds of commercially-available products can be used. As the products, examples include, but are not limited to, SPZ-100F (product name, zinc stearate particles manufactured by: Sakai Chemical Industry Co., Ltd., number average primary particle diameter: 0.5 μm) and SPX-100F (product name, magnesium stearate particles manufactured by: Sakai Chemical Industry Co., Ltd., number average primary particle diameter: 0.72 μm).

The number average primary particle diameter of the external additive particles used in the present disclosure can be measured as follows. First, for each of the particles of the external additive, the particle diameter is measured by a transmission electron microscope (TEM) or the like. The particle diameters of at least 200 external additive particles are measured in this manner, and the average is defined as the number average primary particle diameter of the particles.

As the external addition treatment method for adding the external additive on the surface of the colored resin particles, a conventionally-known external addition treatment method can be used, without any particular limitation. In the present disclosure, the external addition treatment is preferably an external addition treatment including the following steps: the first step in which intermediate particles are obtained by mixing and stirring part of the external additive to be added and the colored resin particles in a wet state, and then drying them, and the second step in which the rest of the external additive and the intermediate particles are mixed and stirred. As just described, by carrying out the external addition treatment in two steps, the external additive added before drying the colored resin particles is relatively likely to penetrate to the surface of the colored resin particles, and the external additive added after drying the colored resin particles is relatively unlikely to penetrate to the surface of the colored resin particles. Accordingly, the surface roughness of the toner particles become appropriate, and the toner having the desired CBD and flowability can be easily obtained.

The moisture content of the wet-state colored resin particles which are used in the first step of the external addition treatment, is preferably from 5% to 20%, more preferably from 6% to 15%, and still more preferably from 7% to 12%.

The moisture content of the intermediate particles which are used in the second step of the external addition treatment, is preferably 1% or less, more preferably 0.8% or less, and still more preferably 0.5% or less.

By controlling the moisture content as just described, the toner having the desired CBD and flowability can be easily obtained.

The external additive added in the first step of the external addition treatment preferably contains the inorganic fine particles C. More preferably, it is composed of the inorganic fine particles C.

The external additive added in the second step of the external addition treatment preferably contains the organic fine particles D. More preferably, it contains the organic fine particles D and the inorganic fine particles A and B.

Accordingly, the toner having the desired CBD and flowability can be easily obtained.

In the first step of the external addition treatment, the colored resin particles may be dried after mixing and stirring the colored resin particles in the wet state and the external additive. It is preferable that the colored resin particles in the wet state are dried while mixing them with the external additive and stirring them. That is, it is preferable to carry out the mixing and stirring concurrently with the drying. The drying method employed in the first step of the external addition treatment is not particularly limited. For example, reduced-pressure drying, vacuum drying, heat drying or the like can be employed.

The second step of the external addition treatment is not particularly limited. For example, a mixer capable of mixing and stirring, such as HENSCHEL MIXER (product name, manufactured by: Mitsui FM Mining Co., Ltd.), MIXER (product name, manufactured by: NIPPON COKE & ENGINEERING CO., LTD.), SUPER MIXER (product name, manufactured by: KAWATA Manufacturing Co., Ltd.), Q MIXER (product name, manufactured by: NIPPON COKE & ENGINEERING CO., LTD.), MECHANOFUSION SYSTEM (product name, manufactured by: Hosokawa Micron Corporation) and MECHANOMILL (product name, manufactured by: Okada Seiko Co., Ltd.) can be used for performing the external addition treatment.

The CBD and flowability of the obtained toner can be controlled by changing the peripheral speed condition of stirring blades, the external addition treatment time and so on in the external addition treatment. For example, as the peripheral speed of stirring blades or the external addition treatment time increases, the CBD and the flowability tend to increase. On the other hand, as the peripheral speed of stirring blades or the external addition treatment time decreases, the CBD and the flowability tend to decrease.

From the point of view that the toner having the desired CBD and flowability can be easily obtained, the peripheral speed of the stirring blades in the external addition treatment is preferably from 35 m/s to 55 m/s, and more preferably from 40 m/s to 50 m/s. The external addition treatment time is preferably from 6 minutes to 15 minutes, and more preferably from 6 minutes to 12 minutes. In the method of carrying out the external addition treatment in two steps, the peripheral speed of the stirring blades and the external addition treatment time in the second step of the external addition treatment are preferably set as described above.

Also when the external addition treatment is carried out in two steps, the mixing and stirring condition of the first step of the external addition treatment is not particularly limited. For example, the rotation speed may be from 100 rpm to 200 rpm; the temperature may be from 20° C. to 40° C.; and the mixing and stirring time may be from 10 hours to 48 hours.

The toner of the first present disclosure is a toner such that the occurrence of spouting of the toner when enduring in a high temperature and high humidity environment is suppressed. After an endurance test in which the toner of the first present disclosure is left to stand for 24 hours in a high temperature and high humidity environment and continuous printing is carried out on up to 5000 sheets of paper at an image density of 5% in the same environment, it is preferable that the toner does not spout from the developing roller of a cartridge, and it is more preferable that when the cartridge is tilted after the endurance test, the toner spouts from only a part of the developing roller or it does not spout from the developing roller.

In the present disclosure, a test for spouting of the toner when enduring in a high temperature and high humidity environment, is carried out as follows. The toner is packed in the toner cartridge of the developing device of a commercially-available, non-magnetic one-component development printer; the cartridge filled with the toner is sealed to avoid the influence of humidity; in this state, the toner cartridge is left to stand under a high temperature and high humidity (H/H) environment (temperature: 35° C., humidity: 80% RH) for 24 hours; and then, the toner spouting test is carried out under the same environment. The toner spouting test can be carried out in the same manner as the test for spouting of the toner when enduring in a high temperature and high humidity environment, which is described below in “Examples”.

The toner of the first present disclosure is a toner which has good storage stability and in which a decrease in the blocking occurrence temperature (heat resistant temperature) is suppressed. The blocking occurrence temperature (heat resistant temperature) of the toner of the first present disclosure is preferably 54° C. or higher, more preferably 55° C. or higher, and still more preferably 56° C. or higher. In the present disclosure, the blocking occurrence temperature of the toner is defined as the maximum temperature at which, when the toner is stored at a constant temperature for 8 hours, the mass of the toner to be aggregated is 5% by mass or less of the total amount of the toner. The blocking occurrence temperature of the toner can be measured by the same method as the measurement of the heat resistant temperature of the toner, which is described below in “Examples”.

The toner of the first present disclosure has good low-temperature fixability. When a solid image is printed on a sheet using a printer in which the temperature of the fixing roller is set to 150° C., and a rubbing test is carried out on the solid area, the density decrease ratio of the toner is preferably 30% or less, more preferably 25% or less, and still more preferably 20% or less.

The density decrease ratio is obtained by the following formula, as the ratio of a difference in the image density before and after the rubbing test (ID (before)−ID (after)) to the image density before the rubbing test (ID (before)).

$$Density decrease ratio ( \% ) = \{ [ ID ( before ) - ID ( after ) ] / ID ( before ) \} \times 100$$

The rubbing test is carried out by attaching the measurement area to a fastness tester with an adhesive tape, applying a 500 g load, and carrying out reciprocating rubbing 5 times with a rubbing terminal wrapped with a cotton cloth.

In the present disclosure, the solid area is an area in which the developer is controlled to adhere to all dots within the area, which are virtual dots for controlling the printer control unit.

### II. Toner of the Second Present Disclosure

The toner of the second present disclosure is a toner comprising colored resin particles containing a binder resin, a colorant, a softening agent and a charge control agent, and an external additive,
wherein fatty acid metal salt particles are contained as the external additive;
wherein a glass transition temperature (Tg) specified from a temperature dependence curve for a loss tangent (tan δ) of the toner, which is obtained by a dynamic viscoelastic measurement of the toner at a measurement frequency of 24 Hz, satisfies 65.0° C.≤Tg (° C.)≤75.0° C.;
wherein, in the temperature dependence curve for the loss tangent (tan δ) where tan δ (Tg) is a loss tangent (tan δ) at Tg and tan δ (100° C.) is a loss tangent (tan δ) at 100° C., an area of a trapezoid where the upper base, lower base and height are a value of tan δ (100° C.), a value of tan δ (Tg) and a value of 100−Tg, respectively, is 35.0 or more and 48.0 or less; and
wherein a ratio of a blow-off charge amount of the toner after a stirring time of 1800 seconds to a blow-off charge amount of the toner after a stirring time of 180 seconds, both of which are measured by the charge amount measurement method described below, is 0.50 or more and 1.00 or less.

As for the toner of the second present disclosure, the toner has such specific viscoelasticity, that the glass transition temperature (Tg) specified from the temperature dependence curve for the loss tangent (tan δ) is 65.0° C. or more and 75.0° C. or less and that the area of the trapezoid, which is specified from the temperature dependence curve for the loss tangent (tan δ), is 35.0 or more and 48.0 or less, and the toner has a charge amount ratio (1800 s/180 s), which is measured by the below-described specific charge amount measurement method, of 0.50 or more and 1.00 or less. Accordingly, the toner is a toner such that both the low-temperature fixability and the storage stability are improved in a well-balanced manner, and spouting of the toner when enduring in a high temperature and high humidity environment is suppressed. The toner has excellent performance which has been difficult to realize in the past.

In the present disclosure, the ratio of the blow-off charge amount of the toner after a stirring time of 1800 seconds to the blow-off charge amount of the toner after a stirring time of 180 seconds, both of which are measured by the specific charge amount measurement method described below, may be referred to as “charge amount ratio (1800 s/180 s)”.

Toner spouting occurs for the following reason, for example. When heat is generated by the sliding of a developing roller and is locally applied to a toner accumulated in the vicinity of the blade or sealing part of a cartridge, the accumulated toner is thermofused into an aggregate, and the aggregate melts and spouts from the developing roller, thereby causing the toner to spout out. Also, toner spouting occurs when, due to a decrease in the charge amount of the toner when enduring, the toner is not loaded on a developing roller and leaks. Toner spouting is likely to occur in a high temperature and high humidity environment for the following reasons: the charge amount itself of a toner tends to decrease; the flowability is likely to decrease due to the moisture absorption of the toner; and heat is further applied to the toner in the high temperature environment.

Meanwhile, during a fixing process or storage, a toner does not deform suddenly when it reaches a certain temperature; however, it gradually deforms along with increased temperature or with the lapse of time in which it is kept at a certain temperature. Based on these properties of the toner, the present inventors found the following: the characteristics of a toner such that the low-temperature fixability and the storage stability are in good balance and toner spouting can be easily suppressed, appear in the glass transition temperature (Tg) and the area of the trapezoid, which are specified from the temperature-tan δ curve. In addition, the present inventors found that by controlling the charge amount ratio (1800 s/180 s) of the toner, which is measured by the specific method, spouting of the toner can be suppressed even when enduring in a high temperature and high humidity environment.

First, by controlling the Tg of the toner and the area of the trapezoid, both of which are specified from the temperature-tan δ curve, within the ranges specified above, the low-temperature fixability and the storage stability can be improved in a well-balanced manner. This is as described above in relation to the toner of the first present disclosure.

The charge amount ratio (1800 s/180 s) can be used as the index of the charge stability of the toner when enduring. As the charge amount ratio (1800 s/180 s) comes close to 1.00, the charge stability of the toner when enduring improves further. When the charge amount ratio (1800 s/180 s) is 0.50 or more and 1.00 or less, a decrease in the charge amount of the toner when enduring is sufficiently suppressed, and the toner can maintain the charge amount required for being loaded on a developing roller. Accordingly, spouting of the toner is suppressed.

Therefore, by controlling the Tg and the area of the trapezoid, which are specified from the temperature-tan δ curve at a measurement frequency of 24 Hz, within the above-specified ranges, and by controlling the charge amount ratio (1800 s/180 s) as described above, the toner of the second present disclosure can be a toner having the following characteristics: the toner is excellent in balance between low-temperature fixability and storage stability; the toner is less likely to accumulate; and the charge amount of the toner is less likely to decrease when enduring. As a result of these characteristics, spouting of the toner when enduring is remarkably suppressed, and the occurrence of spouting of the toner can be suppressed even when enduring in a high temperature and high humidity environment.

Hereinafter, the characteristics of the toner of the second present disclosure, a method for producing colored resin particles used for the toner of the second present disclosure, the colored resin particles, an external additive used for the toner of the second present disclosure, a method for adding the external additive, and the performance of the toner of the second present disclosure, will be described in this order.

### II-1. Characteristics of the Toner

### [Viscoelasticity]

The viscoelasticity of the toner of the second present disclosure is the same as the above-described viscoelasticity of the toner of the first present disclosure.

[Charge Amount Ratio (1800 s/180 s)]

As for the toner of the present disclosure, the ratio of the blow-off charge amount of the toner after a stirring time of 1800 seconds, which is measured by the charge amount measurement method described below, to the blow-off charge amount of the toner after a stirring time of 180 seconds, which is measured by the charge amount measurement method described below, is 0.50 or more and 1.00 or less. In the present disclosure, the ratio may be referred to as “charge amount ratio (1800 s/180 s)”. When enduring in the high temperature and high humidity environment, a decrease in the charge amount of the toner is sufficiently suppressed due to the toner having the charge amount ratio (1800 s/180 s) within the above range; therefore, spouting of the toner is suppressed. Also, the inventors of the present disclosure found the following: an excellent initial charge speed is obtained when the charge amount ratio (1800 s/180 s) is 1.00 or less. When the initial charge speed is insufficient, failures are likely to occur, such as the occurrence of toner spouting in the early stage of printing. From the viewpoint of improving the initial charge speed, the charge amount ratio (1800 s/180 s) is preferably 0.90 or less, and more preferably 0.80 or less.

### [Charge Amount Measurement Method]

First, 0.25 g of the toner and 9.75 g of a spherical, non-coated Mn—Mg—Sr—Fe type ferrite carrier having an average particle diameter of 60 μm, are put in a glass container having a volume of 30 cc (inner bottom diameter 30 mm, height 50 mm); in an environment at 23° C. and a relative humidity of 50%, a triboelectric charging treatment is carried out by stirring them by use of a roller mixer at a rotation of 160 rpm for a predetermined time, that is, 180 seconds or 1800 seconds; 0.2 g of a mixture of the toner and ferrite carrier after the triboelectric charging treatment, is put in a Faraday cage; and by use of a blow-off powder charge amount measuring device, the toner is blown off for 30 seconds in a condition of a nitrogen gas pressure of 0.098 MPa, and the blow-off charge amount (μC/g) of the toner is measured.

The blow-off charge amount (μC/g) of the toner can be calculated by the following formula (1).

$$Blow - off charge amount ( μ C / g ) of the toner = [ Blow - off charge amount ( μ C ) of the mixture ] / \{ [ Weight of the mixture ( 0.2 g ) ] \times [ \text{} Percentage of the toner contained in the mixture ( 2.5 \% ) ] \} \qquad Formula ( 1 )$$

As the ferrite carrier used in the charge amount measurement method, for example, EF-60 (product name, manufactured by: Powdertech Corporation, Mn—Mg—Sr—Fe type, spherical, non-coated with resin, average particle diameter 60 μm) can be used, which is a standard carrier.

As the blow-off powder charge amount measuring device used in the charge amount measurement method, for example, BLOW-OFF TYPE Q/M METER (product name, manufactured by: TREK JAPAN) can be used.

In the toner of the present disclosure, from the viewpoint of suppressing toner spouting in a high temperature and high humidity environment, the blow-off charge amount after a stirring time of 1800 seconds, which is measured by the charge amount measurement method, is preferably 20 μC/g or more, and more preferably 25 μC/g or more. The upper limit of the blow-off charge amount is not particularly limited. From the viewpoint of optimizing image density, the upper limit is preferably 40 μC/g or less, and more preferably 35 μC/g or less.

The toner of the present disclosure having the above-described characteristics can be obtained by controlling, for example, the composition, molecular weight and content of the binder resin contained in the toner, the type and content of the external additive, and the toner production condition such as the external addition treatment condition. The viscoelasticity of the toner can be controlled mainly by controlling the composition, molecular weight and content of the binder resin, and the type and content of the external additive. The charge amount ratio (1800 s/180 s) of the toner can be controlled mainly by controlling the type and amount of the added external additive, or it can be controlled by adding a polar resin to the colored resin particles, for example.

To obtain the toner of the present disclosure having the above-described characteristics, more specifically, it is effective to employ the below-described preferred embodiments as the components used for the toner production and as method for producing the toner.

### II-2. Method for Producing Colored Resin Particles

As with the colored resin particles used in the toner of the first present disclosure, the colorant resin particles used in the toner of the second present disclosure can be produced by using a wet method or a dry method. The colorant resin particles used in the toner of the second present disclosure are preferably produced by a wet method, and they can be produced by using a suspension polymerization method, which is particularly preferable among the wet methods.

### (A) Suspension Polymerization Method

The method for producing the colored resin particles used in the toner of the second present disclosure by the suspension polymerization method, is almost the same as the method described in the first present disclosure. Differences from the first present disclosure will be described below.

In the second present disclosure, the content of the polymerizable monomer used in “(A-1) Preparation step of polymerizable monomer composition” is appropriately controlled so that the toner obtains the above-specified viscoelasticity, and it is not particularly limited. With respect to the total solid content (100 parts by mass) contained in the polymerizable monomer composition, the content of the polymerizable monomer is preferably from 70 parts by mass to 99 parts by mass, more preferably from 75 parts by mass to 97 parts by mass, and still more preferably from 80 parts by mass to 95 parts by mass.

In the second present disclosure, as the colorant used in “(A-1) Preparation step of polymerizable monomer composition”, examples include, but are not limited to, those exemplified above in the first present disclosure. From the point of view that the toner having the above-specified viscoelasticity can be easily obtained, as the black colorant, carbon black is preferred. As the cyan colorant, a phthalocyanine pigment such as a copper phthalocyanine pigment and a derivative thereof is preferred, and particularly preferred is C.I. Pigment Blue 15:3. As the yellow colorant, an azo-based pigment such as a disazo pigment is preferred, and particularly preferred is C.I. Pigment Yellow 155. As the magenta colorant, a condensed polycyclic pigment such as a quinacridone pigment is preferred, and particularly preferred is C.I. Pigment Red 122.

In the second present disclosure, the content of the colorant is preferably from 1 part by mass to 20 parts by mass, more preferably from 5 parts by mass to 15 parts by mass, and still more preferably from 7 parts by mass to 13 parts by mass, with respect to 100 parts by mass of the polymerizable monomer. When the content of the colorant is within the above range, the toner having the above-specified viscoelasticity can be easily obtained.

In the second present disclosure, the description of the softening agent used in “(A-1) Preparation step of polymerizable monomer composition” is the same as that described in the first present disclosure.

In the second present disclosure, as the charge control agent used in “(A-1) Preparation step of polymerizable monomer composition”, examples include, but are not limited to, those exemplified above in the first present disclosure. A positively- or negatively-chargeable charge control resin is preferred, because it has high compatibility with a polymerizable monomer and can impart stable chargeability (charge stability) to the toner particles, and the toner having the desired charge amount ratio (1800 s/180 s) can be easily obtained.

As the positively- or negatively-chargeable charge control resin, examples include, but are not limited to, those exemplified above in the first present disclosure. Those that are preferably used in the first present disclosure can be preferably used also in the second present disclosure.

From the viewpoint that the toner having the above-specified viscoelasticity can be easily obtained, in the functional group-containing copolymer that is used as a positively- or negatively-chargeable charge control resin, the content ratio of the functional group-containing constitutional unit is preferably 10% by mass or less, and more preferably 8% by mass or less. On the other hand, from the point of view that the toner having the desired charge amount ratio (1800 s/180 s) can be easily obtained, and the storage stability of the toner is improved, the content ratio of the functional group-containing constitutional unit in the functional group-containing copolymer is preferably 1.0% by mass or more, and more preferably 3.0% by mass or more. It is presumed that, when the charge control resin sufficiently contains the functional group, the charge control resin is likely to be localized near the surface of each colorant resin particle, and the charge control resin functions like the shell of the colored resin particles, thereby improving the charge stability and storage stability of the toner, and suppressing the occurrence of spouting of the powder in a high temperature and high humidity environment.

In the second present disclosure, the charge control resin is used in an amount of generally from 0.1 parts by mass to 10 parts by mass, preferably from 0.3 parts by mass to 5 parts by mass, and more preferably from 0.6 parts by mass to 1.5 parts by mass, with respect to 100 parts by mass of the monovinyl monomer.

When the content of the charge control resin is equal to or more than the lower limit value, the occurrence of fog can be suppressed. On the other hand, when the content of the charge control resin is equal to or less than the upper limit value, printing stains can be suppressed. When the content of the charge control resin is within the above range, the toner having the desired charge amount ratio (1800 s/180 s) can be easily obtained.

In the second present disclosure, in the case of using a charge control agent other than the charge control resin, the content of the charge control agent other than the charge control resin is preferably 10 parts by mass or less, and more preferably 5 parts by mass or less, with respect to 100 parts by mass of the charge control resin.

In the second present disclosure, as the molecular weight modifier used in “(A-1) Preparation step of polymerizable monomer composition, examples include, but are not limited to, those exemplified above in the first present disclosure.

In the second present disclosure, from the viewpoint that the toner having the above-specified viscoelasticity can be easily obtained, it is preferable that the content of the molecular weight modifier is adjusted so that the weight average molecular weight Mw of the polymer contained in the binder resin falls within the preferable range described later.

The molecular weight modifier is used in an amount of preferably from 1.0 part by mass to 3.0 parts by mass, and more preferably from 1.1 parts by mass to 2.0 parts by mass, with respect to 100 parts by mass of the monovinyl monomer.

As the content of the molecular weight modifier increases, the weight average molecular weight of the polymer contained in the binder resin is likely to decrease.

In the second present disclosure, the polymerizable monomer composition may contain a polar resin. When the polymerizable monomer composition contains a polar resin, the charge amount ratio (1800 s/180 s) of the toner can be controlled, and the particle diameter of the colored resin particles can be easily controlled.

In the present disclosure, the polar resin is selected from the group consisting of polymers each containing a repeating unit including a heteroatom. As the polar resin, examples include, but are not limited to, an acrylic resin, a polyester resin, and a vinyl resin containing a heteroatom.

The polar resin may be a homopolymer or copolymer of a heteroatom-containing monomer, or it may be a copolymer of a heteroatom-containing monomer and a heteroatom-free monomer. When the polar resin is a copolymer of a heteroatom-containing monomer and a heteroatom-free monomer, in 100% by mass of all repeating units constituting the copolymer, the percentage of the heteroatom-containing monomer unit is preferably 50% by mass or more, more preferably 70% by mass or more, and still more preferably 90% by mass or more, since the toner having the desired charge amount ratio (1800 s/180 s) can be easily obtained, and the particle diameter of the colored resin particles can be easily controlled.

As the heteroatom-containing monomer used in the polar resin, examples include, but are not limited to, a (meth)acryloyl group-containing monomer, that is, a (meth)acrylic monovinyl monomer such as an alkyl (meth)acrylate (e.g., methyl(meth)acrylate, ethyl(meth)acrylate, n-propyl(meth)acrylate, isopropyl(meth)acrylate, n-butyl(meth)acrylate, isobutyl(meth)acrylate, sec-butyl(meth)acrylate, tert-butyl(meth)acrylate, n-pentyl(meth)acrylate, sec-pentyl(meth)acrylate, isopentyl(meth)acrylate, neopentyl(meth)acrylate, n-hexyl(meth)acrylate, isohexyl(meth)acrylate, neohexyl(meth)acrylate, sec-hexyl(meth)acrylate, tert-hexyl(meth)acrylate, 2-ethylhexyl(meth)acrylate, lauryl (meth)acrylate), a (meth)acrylic acid ester (e.g., 2-hydroxyethyl(meth)acrylate, 2-hydroxypropyl(meth)acrylate, 4-hydroxybutyl(meth)acrylate, methoxypolyethylene glycol (meth)acrylate, dimethylaminoethyl(meth)acrylate, diethylaminoethyl(meth)acrylate, glycidyl(meth)acrylate, 4-hydroxybutyl acrylate glycidyl ether) and (meth)acrylic acid; an aromatic vinyl monomer containing a heteroatom, such as halogenated styrene and styrene sulfonate; a carboxylic acid vinyl ester monomer such as vinyl acetate; a vinyl halide monomer such as vinyl chloride; a vinylidene halide monomer such as vinylidene chloride; a vinylpyridine monomer; a carboxyl group-containing monomer such as an ethylenically unsaturated carboxylic acid monomer (e.g., crotonic acid, cinnamic acid, itaconic acid, fumaric acid, maleic acid, butene tricarboxylic acid); and an epoxy group-containing monomer such as allyl glycidyl ether. In the present disclosure, (meth)acrylate means each of acrylate and methacrylate, and (meth)acryl means each of acryl and methacryl. These heteroatom-containing monomers may be used alone or in combination of two or more.

As the heteroatom-free monomer used in the polar resin, examples include, but are not limited to, a heteroatom-free, aromatic vinyl monomer such as styrene, vinyltoluene, α-methylstyrene and p-methylstyrene; a monoolefin monomer such as ethylene, propylene and butylene; and a diene monomer such as butadiene and isoprene. These heteroatom-free monomers may be used alone or in combination of two or more.

As the polar resin, such a heteroatom-containing monomer is preferred, that contains at least one kind of polar group-containing monomer unit which contains at least one kind of polar group selected from the group consisting of a carboxyl group, a hydroxyl group, a sulfonic acid group, an amino group, a polyoxyethylene group and an epoxy group, from the point of view that the toner having the desired charge amount ratio (1800 s/180 s) can be easily contained, and the particle diameter of the colored resin particles can be easily controlled. The polar group is preferably at least one kind selected from a carboxyl group and a hydroxyl group.

As the polar group-containing monomer, examples include, but are not limited to, the following: a carboxyl group-containing monomer such as an ethylenically unsaturated carboxylic acid monomer (e.g., acrylic acid, methacrylic acid, crotonic acid, cinnamic acid, itaconic acid, fumaric acid, maleic acid, butene tricarboxylic acid); a hydroxyl group-containing monomer such as 2-hydroxyethyl(meth)acrylate, 2-hydroxypropyl (meth)acrylate and 4-hydroxybutyl (meth)acrylate; a sulfonic acid group-containing monomer such as styrene sulfonate; an amino group-containing monomer such as dimethylaminoethyl (meth)acrylate and diethylaminoethyl (meth)acrylate; a polyoxyethylene group-containing monomer such as methoxypolyethylene glycol (meth)acrylate; and an epoxy group-containing monomer such as glycidyl(meth)acrylate, allyl glycidyl ether and 4-hydroxybutyl acrylate glycidyl ether. These polar group-containing monomers may be used alone or in combination of two or more.

When the polar resin contains the polar group-containing monomer unit, the polar group is preferably disposed at the terminal of the main chain or a side chain, or they are preferably bound to the main chain or a side chain in a pendant shape, from the point of view that the polar resin can be easily disposed at the surface of the droplets of the polymerizable monomer composition; the toner having the desired charge amount ratio (1800 s/180 s) can be easily obtained; and the particle diameter of the colored resin particles can be easily controlled.

When the polar resin is free of the polar group-containing monomer unit, the heteroatom-containing monomer unit contained in the polar resin preferably contains monomer unit derived from an alkyl(meth)acrylate, from the viewpoint of high compatibility with the polymerizable monomer; the toner having the desired charge amount ratio (1800 s/180 s) can be easily obtained; and the particle diameter of the colored resin particles can be easily controlled. Especially, from the viewpoint of high polarity, the heteroatom-containing monomer unit more preferably contains a monomer unit derived from an alkyl (meth)acrylate in which the number of the carbon atoms of the alkyl group is 3 or less, still more preferably a monomer unit derived from at least one selected from methyl (meth)acrylate and ethyl(meth)acrylate, and even more preferably a monomer unit derived from methyl (meth)acrylate.

The polar resin is preferably a copolymer of at least one kind selected from an acrylic ester and a methacrylic ester and at least one kind selected from acrylic acid and methacrylic acid, and more preferably a copolymer of an acrylic ester, a methacrylic ester and acrylic acid, from the point of view that high compatibility with the polymerizable monomer is obtained; the toner having the desired charge amount ratio (1800 s/180 s) can be easily obtained; and the particle diameter of the colored resin particles can be easily controlled. In the present disclosure, such a polymer of (meth)acrylic acid ester and (meth)acrylic acid may be referred to as a “acrylic copolymer”.

In the acrylic copolymer, as the (meth)acrylic acid ester, examples include, but are not limited to, those exemplified above as the (meth)acrylic acid ester used in the heteroatom-containing monomer. In the acrylic copolymer, the (meth)acrylic acid ester may be a (meth)acrylic acid ester containing the polar group, or it may be a (meth)acrylic acid ester free of the polar group. The (meth)acrylic acid ester is preferably a (meth)acrylic acid ester free of the polar group, and it is more preferably an alkyl (meth)acrylate. The acrylic ester used in the acrylic copolymer is preferably at least one kind selected from the group consisting of ethyl acrylate, n-propyl acrylate, isopropyl acrylate and n-butyl acrylate, and it is more preferably at least one kind selected from ethyl acrylate and n-butyl methacrylate. The methacrylic ester used in the acrylic copolymer is preferably at least one kind selected from the group consisting of methyl methacrylate, n-propyl methacrylate, isopropyl methacrylate and n-butyl methacrylate, and it is more preferably methyl methacrylate.

In the acrylic copolymer, the percentage of the (meth)acrylic acid with respect to the total amount (100% by mass) of the (meth)acrylic acid ester and (meth)acrylic acid used for the synthesis of the acrylic copolymer, is preferably from 0.05% by mass to 18 by mass, more preferably from 0.1% by mass to 0.6% by mass, and still more preferably from 0.3% by mass to 0.5% by mass, from the point of view that the compatibility with the polymerizable monomer is high; the toner having the desired charge amount ratio (1800 s/180 s) can be easily obtained; and the particle diameter of the colored resin particles can be easily controlled.

The acrylic copolymer is preferably a copolymer of monomers which contain 50.0% by mass or more of methyl methacrylate with respect to the total mass (100% by mass) of the monomers used for the synthesis of the copolymer, from the point of view that the compatibility with the polymerizable monomer is high; the toner having the desired charge amount ratio (1800s/180 s) can be easily obtained; and the particle diameter of the colored resin particles can be easily controlled. The acrylic copolymer is more preferably a copolymer of monomers which contain 50.0% by mass to 99.9% by mass of methyl methacrylate and 0.1% by mass to 5.0% by mass of (meth)acrylic acid, still more preferably a copolymer of monomers which contain 50.0% by mass to 99.0% by mass of methyl methacrylate and 0.1% by mass to 5.0% by mass of (meth)acrylic acid, even more preferably a copolymer of monomers which contain 50.0% by mass to 98.0% by mass of methyl methacrylate, 1.0% by mass to 5.0% by mass of alkyl (meth)acrylate different from methyl methacrylate, and 0.1% by mass to 5.0% by mass of (meth)acrylic acid, and particularly preferably a copolymer of monomers which contain 50.0% by mass to 98.0% by mass of methyl methacrylate, 1.0% by mass to 5.0% by mass of alkyl (meth)acrylate different from methyl methacrylate, and 0.2% by mass to 3.0% by mass of (meth)acrylic acid.

As the alkyl (meth)acrylate different from methyl methacrylate, at least one selected from ethyl acrylate and butyl acrylate is preferred, from the point of view that the glass transition temperature can be controlled.

The acrylic copolymer may contain a small amount of monomer unit derived from another monomer that is different from any of (meth)acrylic acid ester and (meth)acrylic acid. In the total amount (100% by mass) of the monomers used for the synthesis of the acrylic copolymer, the content of the another monomer is preferably 30% by mass or less, more preferably 20% by mass or less, and still more preferably 10% by mass or less. It is most preferable that the another monomer is not contained.

The acid value of the polar resin is preferably from 0.5 mgKOH/g to 7.0 mgKOH/g, more preferably from 1.0 mgKOH/g to 5.0 mgKOH/g, and still more preferably from 1.5 mgKOH/g to 3.0 mgKOH/g. When the acid value of the polar resin is equal to or more than the lower limit value, the heat-resistant storage stability, low-temperature fixability and printing durability of the toner can be improved. When the acid value of the polar resin is equal to or less than the upper limit value, the particle diameter of the colored resin particles can be easily controlled.

In the present disclosure, the acid value is a value measured according to JIS K 0070 (standard methods for the analysis of oils and fats, established by JAPAN Industrial Standards Committee (JICS)).

The weight average molecular weight (Mw) of the polar resin is preferably from 8,000 to 45,000, more preferably from 9,000 to 45,000, and still more preferably from 10,000 to 40,000. When the weight average molecular weight (Mw) of the polar resin is equal to or more than the lower limit value, the heat-resistant storage stability and durability of the toner can be improved. When the weight average molecular weight (Mw) of the polar resin is equal to or less than the upper limit value, an increase in the fixing temperature of the toner can be suppressed.

In the present disclosure, the weight average molecular weight (Mw) of the polymer can be obtained as a polystyrene equivalent molecular weight by GPC, using a sample dissolved in tetrahydrofuran (THE).

The glass transition temperature (Tg) of the polar resin is preferably from 60° C. to 95° C., more is preferably from 65° C. to 90° C., and still more is preferably from 70° C. to 80° C.

When the glass transition temperature of the polar resin is equal to or more than the lower limit value, the heat-resistant storage stability of the toner can be improved. When the grass transition temperature of the toner is equal to or less than the upper limit value, the low-temperature fixability of the toner can be improved.

The grass transition temperature Tg of the polar resin can be obtained according to ASTM D3418-82, for example. More specifically, using a differential scanning calorimeter (SSC5200 manufactured by Seiko Instruments & Electronics Ltd.) or the like, the temperature of a sample is increased at a temperature increase rate of 10° C./min, thereby obtaining a DSC curve; and the temperature indicating the maximum endothermic peak in the DSC curve can be used as the grass transition temperature.

A commercially-available product can be used as the polar resin, or the polar resin can be produced by polymerizing a monomer containing the heteroatom-containing monomer by a known polymerization method such as a solution polymerization method, an aqueous solution polymerization method, an ionic polymerization method, a high-temperature and high-pressure polymerization method and a suspension polymerization method.

When the polar resin is a copolymer, the copolymer may be any of a random copolymer, a block copolymer and a graft copolymer. The copolymer is preferably a random copolymer.

From the viewpoint of improving solubility, the polar resin is preferably finely pulverized.

When the polar resin is contained, the content of the polar resin is preferably from 0.8 parts by mass to 2.5 parts by mass, and more preferably from 1.0 part by mass to 2.0 parts by mass, with respect to 100 parts by mass of the polymerizable monomer. When the content of the polar resin is equal to or more than the lower limit value, the toner having the desired charge amount ratio (1800 s/180 s) can be easily obtained, and the particle diameter of the colored resin particles can be easily controlled. On the other hand, when the content of the polar resin is equal to or less than the upper limit value, an increase in the fixing temperature of the toner can be suppressed.

In the second present disclosure, “(A-2) Suspension step (droplet forming step) to obtain suspension”, “(A-3) Polymerization step” and “(A-4) Washing, filtrating and dehydrating step” are the same as those described in the first present disclosure.

### (B) Pulverization Method

In the second present disclosure, the method for producing the colored resin particles by employing the pulverization method, is the same as those described in the first present disclosure.

### II-3. Colored Resin Particles

The colored resin particles are obtained by the production method such as the above-mentioned “(A) Suspension Polymerization Method” and “(B) Pulverization Method”.

Hereinafter, the colored resin particles contained in the toner of the second present disclosure will be described. The colored resin particles described below include both core-shell type colored resin particles and colored resin particles which are not core-shell type.

The colored resin particles used in the second present disclosure contains the binder resin, the colorant, the softening agent and the charge control agent, and they may further contain other additives, if necessary.

Examples of the binder resin contained in the colored resin particles include a polymer obtained by polymerizing the polymerizable monomer in described “(A) Suspension Polymerization Method” (including the contents quoted from the first present disclosure (the same shall apply hereinafter)). Preferable polymerizable monomers which derive each constitutional unit of the polymer are the same as the preferable polymerizable monomers described in “(A) Suspension Polymerization Method”. In the second present disclosure, the description of the composition, weight average molecular weight Mw and content of the binder resin contained in the colored resin particles is the same as that described in the first present disclosure.

The colorant, softening agent and charge control agent contained in the colored resin particles are the same as those of the above-described (A) Suspension Polymerization Method” (including the content of the first present disclosure).

In the second present disclosure, the content of the colorant and softening agent contained in the colored resin particles are the same as that in the first present disclosure.

In the second present disclosure, the content of the charge control resin contained in the colored resin particles is preferably from 0.1 parts by mass to 10 parts by mass, more preferably from 0.3 parts by mass to 5 parts by mass, and still more preferably from 0.6 parts by mass to 1.5 parts by mass, with respect to 100 parts by mass of the binder resin. When the content of the charge control resin is equal to or more than the lower limit value, the occurrence of fog can be suppressed. When the content is equal to or less than the upper limit value, printing stains can be suppressed. When the content of the charge control resin is within the above range, the toner having the desired charge amount ratio (1800 s/180 s) can be easily obtained.

### II-4. Toner of the Second Present Disclosure

The toner of the second present disclosure contains the above-described colored resin particles and the external additive. As the external addition treatment, the colored resin particles are mixed and stirred with the external additive to add the external additive on the surface of the colored resin particles, thereby obtaining a one-component toner (developer). The one-component toner may be mixed and stirred with carrier particles to obtain a two-component developer. From the point of view that the effects of the present disclosure can be easily obtained, the toner of the present disclosure is preferably a toner that is used as a one-component toner.

Also, from the point of view that the effect of the present disclosure can be easily obtained, the toner of the present disclosure is preferably a non-magnetic toner free of magnetic powder, and it is more preferably a non-magnetic one-component toner.

The toner of the second present disclosure contains fatty acid metal salt particles as the external additive. Accordingly, the toner having the above-specified viscoelasticity and the desired charge amount ratio (1800 s/180 s) can be easily obtained. As disclosed in Patent Document 4, the charge amount ratio (1800 s/180 s) of a toner can be controlled to 0.50 to 1.00 by using silicone resin particles as the external additive. However, when the charge amount ratio (1800 s/180 s) is controlled to 0.50 to 1.00 by using silicone resin particles, the toner may scatter during the transfer of the toner from a photoconductor to a paper due to low adhesion of the toner, which may result in uneven image density. However, the toner of the present disclosure is a toner such that the charge amount ratio (1800 s/180 s) is controlled to 0.50 to 1.00 by using the fatty acid metal salt particles as the external additive. Accordingly, the uneven image density as described above hardly occurs.

Also, compared to silicone resin particles, the fatty acid metal salt particles can improve the toner's charge stability in a small amount. When the amount of the external additive contained in the toner is too large, the low-temperature fixability of the toner may deteriorate. By using the fatty acid metal salt particles, the external additive amount can be decreased, and a decrease in low-temperature fixability can be suppressed, accordingly. In the toner of the present disclosure, it is presumed that since the fatty acid metal salt particles are rubbed on the toner particles or the whole system and spread in the printer when enduring, the charge stability of the toner improves. Accordingly, it is presumed that the charge stability of the toner is improved even when the amount of the added fatty acid metal salt particles is relatively small.

Moreover, when the toner contains the fatty acid metal salt particles as the external additive, there are the following advantageous effects: filming on a photoconductor is less likely to occur, and such a toner can be easily obtained, that deterioration in image quality (e.g., fog) is less likely to occur even after continuous printing is carried out on many sheets, and a deterioration in image quality is less likely to occur especially even under a high temperature and high humidity environment (HH environment).

The particle diameter of the fatty acid metal salt particles is not particularly limited. From the point of view that the above-described effects by the fatty acid metal salt particles can be effectively exerted, the number average primary particle diameter thereof is preferably 1.0 μm or less, more preferably 0.9 μm or less, and still more preferably 0.8 μm or less. The lower limit is preferably 0.3 μm or more, more preferably 0.4 μm or more, and still more preferably 0.5 μm or more.

The lower limit of the content of the fatty acid metal salt particles is preferably 0.01 parts by mass or more, more preferably 0.02 parts by mass or more, still more preferably 0.03 parts by mass or more, and even more preferably 0.04 parts by mass or more, with respect to 100 parts by mass of the binder resin in the colored resin particles. On the other hand, the upper limit is preferably 0.19 parts by mass or less, more preferably 0.17 parts by mass or less, still more preferably 0.15 parts by mass or less, and even more preferably 0.13 parts by mass or less, with respect to 100 parts by mass of the binder resin in the colored resin particles.

When the content of the fatty acid metal salt particles is equal to or more than the lower limit value, the charge amount ratio (1800 s/180 s) of the toner can easily become 0.50 or more; the charge stability when enduring becomes excellent; the occurrence of spouting of the toner when enduring in a high temperature and high humidity environment is suppressed; and the occurrence of fog can be suppressed. On the other hand, when the content of the fatty acid metal salt particles is equal to or less than the upper limit value, a deterioration in the fixability of the toner, which is due to the large external additive amount, can be suppressed. In addition, a decrease in flowability is suppressed.

The description of the fatty acid moiety (R—COO⁻) of the fatty acid metal salt particles used in the toner of the second present disclosure and the description of the metal contained in the fatty acid metal salt particles, are the same as those described in the first present disclosure. As the commercially-available products of the fatty acid metal salt particles used in the toner of the second present disclosure, examples include, but are not limited to, the same commercially-available products exemplified above in the first present disclosure.

In the second present disclosure, as the external additive, the toner preferably further contains inorganic fine particles A having a number average primary particle diameter of from 36 nm to 100 nm.

When the number average primary particle diameter of the inorganic fine particles A is less than 36 nm, the charge amount ratio (1800 s/180 s) may become less than 0.50, and an adverse effect on printing performance (e.g., fog) may occur due to a decrease in spacer effect thereof. On the other hand, when the number average primary particle diameter of the inorganic fine particles A is more than 100 nm, the charge amount ratio (1800 s/180 s) may become less than 0.50, and an adverse effect on printing performance may occur, since the inorganic fine particles A are likely to be released from the surface of the toner particles, so that the function of the inorganic fine particles A as the external additive decreases.

The lower limit of the number average primary particle diameter of the inorganic fine particles A is more preferably 40 nm or more, and still more preferably from 45 nm. On the other hand, the upper limit is more preferably 80 nm or less, and still more preferably 70 nm or less. Also, the inorganic fine particles A are preferably hydrophobized particles.

In the second present disclosure, for example, a silane coupling agent, silicone oil, fatty acid or fatty acid metal salt can be used as the hydrophobizing agent. Among them, a silane coupling agent and silicone oil are preferred.

The lower limit of the content of the inorganic fine particles A is preferably 0.30 parts by mass or more, more preferably 0.50 parts by mass or more, and still more preferably 1.00 part by mass or more, with respect to 100 parts by mass of the binder resin in the colored resin particles. On the other hand, the upper limit is preferably 2.50 parts by mass or less, more preferably 2.00 parts by mass or less, and still more preferably 1.50 parts by mass or less, with respect to 100 parts by mass of the binder resin in the colored resin particles.

When the content of the inorganic fine particles A is equal to or more than the lower limit value, the inorganic fine particles A can sufficiently function as the external additive. Accordingly, a deterioration in printing performance or storage stability is suppressed. On the other hand, when the content of the inorganic fine particles A is equal to or less than the upper limit value, the release of the inorganic fine particles A from the surface of the toner particles is suppressed. Accordingly, a deterioration in printing performance is suppressed.

In the second present disclosure, as the external additive, the toner preferably further contains inorganic fine particles B having a number average primary particle diameter of from 15 nm to 35 nm.

When the number average primary particle diameter of the inorganic fine particles B is less than 15 nm, the charge amount ratio (1800 s/180 s) may become less than 0.50 and an adverse effect may be imposed on printing performance. On the other hand, when the number average primary particle diameter of the inorganic fine particles B is more than 35 nm, the following problems may occur: the charge amount ratio (1800 s/180 s) may become less than 0.50, and in addition, sufficient flowability may not be imparted to the toner particles due to a decrease in the proportion of the inorganic fine particles B to the surface of the toner particles (the surface coverage).

The lower limit of the number average primary particle diameter of the inorganic fine particles B is more preferably 17 nm or more, and still more preferably 20 nm or more. On the other hand, the upper limit is more preferably 30 nm or less, and still more preferably 25 nm or less. Also, the inorganic fine particles B are preferably hydrophobized particles.

The lower limit of the content of the inorganic fine particles B is preferably 0.10 parts by mass or more, more preferably 0.30 parts by mass or more, and still more preferably 0.50 parts by mass or more, with respect to 100 parts by mass of the binder resin in the colored resin particles. On the other hand, the upper limit is preferably 2.00 parts by mass or less, more preferably 1.50 parts by mass or less, and still more preferably 1.00 part by mass or less, with respect to 100 parts by mass of the binder resin in the colored resin particles.

When the content of the inorganic fine particles B is equal to or more than the lower limit value, the inorganic fine particles B can sufficiently function as the external additive. Accordingly, a decrease in flowability is suppressed, and a deterioration in storage stability or durability is suppressed. On the other hand, when the content of the inorganic fine particles B is equal to or less than the upper limit value, the release of the inorganic fine particles B from the surface of the toner particles is suppressed. Accordingly, a deterioration in charge property is suppressed, thereby suppressing the occurrence of fog.

In the second present disclosure, as the external additive, the toner preferably further contains inorganic fine particles C having a number average primary particle diameter of from 6 nm to 14 nm.

When the number average primary particle diameter of the inorganic fine particles C is less than 6 nm, the charge amount ratio (1800 s/180 s) may become less than 0.50 and an adverse effect may be imposed on printing performance. On the other hand, when the number average primary particle diameter of the inorganic fine particles C is more than 14 nm, the charge amount ratio (1800 s/180 s) may become less than 0.50, and in addition, sufficient flowability may not be imparted to the toner particles due to a decrease in the proportion of the inorganic fine particles C to the surface of the toner particles (the surface coverage).

The lower limit of the number average primary particle diameter of the inorganic fine particles C is more preferably 6.5 nm or more, and still more preferably 7.0 nm or more. On the other hand, the upper limit is more preferably 12 nm or less, and still more preferably 10 nm or less. Also, the inorganic fine particles C are preferably hydrophobized particles.

The lower limit of the content of the inorganic fine particles C is preferably 0.10 parts by mass or more, more preferably 0.15 parts by mass or more, and still more preferably 0.20 parts by mass or more, with respect to 100 parts by mass of the binder resin in the colored resin particles. On the other hand, the upper limit is preferably 1.50 parts by mass or less, more preferably 1.00 part by mass or less, still more preferably 0.80 parts by mass or less, and even more preferably 0.60 parts by mass or less, with respect to 100 parts by mass of the binder resin in the colored resin particles.

When the content of the inorganic fine particles C is equal to or more than the lower limit value, the inorganic fine particles C can sufficiently function as the external additive. Accordingly, a decrease in flowability is suppressed, and a deterioration in storage stability is suppressed. On the other hand, when the content of the inorganic fine particles C is equal to or less than the upper limit value, the release of the inorganic fine particles C from the surface of the toner particles is suppressed. Accordingly, a deterioration in charge property is suppressed, thereby suppressing the occurrence of fog.

The toner of the second present disclosure preferably contains any one of the inorganic fine particles A to C, more preferably contains any two of them, and still more preferably contains all of them. By appropriately controlling the particle diameter and amount of the inorganic fine particles A to C to be added, the viscoelasticity, flowability, fixability, storage stability, charge stability and so on of the toner can be controlled.

The description of the examples and commercially-available products of the inorganic fine particles A, B and C are the same as that described in the first present disclosure.

In the toner of the second present disclosure, as secondary particles, at least part of the inorganic fine particles A, B and C are preferably added on the surface of the colored resin particles, from the viewpoint of increasing the charge amount of the toner.

The toner of the second present disclosure preferably contains, as the external additive, the fatty acid metal salt particles in combination with at least one kind selected from the group consisting of the inorganic fine particles A, B and C, from the point of view that the charge amount and the charge stability are improved, and the effect of suppressing the spouting of the toner in a high temperature and high humidity environment, is improved. It is presumed that since the fatty acid metal salt particles can function as a binder agent for the secondary particles (the inorganic fine particles A, B or C), the secondary particles (the inorganic fine particles A, B or C) are retained even when enduring due to the combination of them, and the charge amount can be kept high, accordingly.

The toner of the second present disclosure may contain another additive which is different from the fatty acid metal salt particles or the inorganic fine particles A to C, to the extent that does not impair the effects of the present disclosure. In 100 parts by mass of the additive, the content of another additive is preferably 10 parts by mass or less, and more preferably 5 parts by mass or less. Accordingly, the occurrence of uneven image density can be suppressed. From the viewpoint of suppressing uneven image density, it is particularly preferable that the content of the silicone resin particles is equal to or less than the upper limit value.

As the external addition treatment method for adding the external additive on the surface of the colored resin particles, a conventionally-known external addition treatment method can be used, without any particular limitation. In the second present disclosure, the external addition treatment is preferably an external addition treatment including the following steps: the first step in which intermediate particles are obtained by mixing and stirring part of the external additive to be added and the colored resin particles in a wet state, and then drying them, and the second step in which the rest of the external additive and the intermediate particles are mixed and stirred. As just described, by carrying out the external addition treatment in two steps, the external additive added before drying the colored resin particles is relatively likely to penetrate to the surface of the colored resin particles, and the external additive added after drying the colored resin particles is relatively unlikely to penetrate to the surface of the colored resin particles. Accordingly, the surface roughness of the toner particles become appropriate, and the low-temperature fixability and the storage stability are improved in a well-balanced manner.

The moisture content of the wet-state colored resin particles which are used in the first step of the external addition treatment, is preferably from 5% to 20%, more preferably from 6% to 15%, and still more preferably from 7% to 12%. The moisture content of the intermediate particles which are used in the second step of the external addition treatment, is preferably 1% or less, more preferably 0.8% or less, and still more preferably 0.5% or less.

The external additive added in the first step of the external addition treatment preferably contains the inorganic fine particles C. More preferably, it is composed of the inorganic fine particles C.

The external additive added in the second step of the external addition treatment preferably contains the fatty acid metal salt particles. More preferably, it contains the fatty acid metal salt particles and the inorganic fine particles A and B.

The description of the methods of the first and second steps of the external addition treatment is the same as that described in the first present disclosure.

From the point of view that the toner of the second present disclosure can be easily obtained, the peripheral speed of the stirring blades in the external addition treatment is preferably from 35 m/s to 55 m/s, and more preferably from 40 m/s to 50 m/s. The external addition treatment time is preferably from 6 minutes to 15 minutes, and more preferably from 6 minutes to 12 minutes. In the method of carrying out the external addition treatment in two steps, the peripheral speed of the stirring blades and the external addition treatment time in the second step of the external addition treatment are preferably set as described above.

Also when the external addition treatment is carried out in two steps, the mixing and stirring condition of the first step of the external addition treatment is not particularly limited. For example, the rotation speed may be from 100 rpm to 200 rpm; the temperature may be from 20° C. to 40° C.; and the mixing and stirring time may be from 10 hours to 48 hours.

The volume average particle diameter (Dv) of the toner of the second present disclosure is preferably from 3 μm to 15 μm, and more preferably from 4 μm to 12 μm. When the Dv of the toner is equal to or more than the lower limit value, the flowability of the toner can be improved; a deterioration in the transfer property of the toner and a decrease in image density can be suppressed; and the occurrence of spouting of the toner when enduring in a high temperature and high humidity environment can be suppressed. On the other hand, when the Dv of the toner is equal to or less than the upper limit value, a decrease in image resolution can be suppressed.

The toner of the second present disclosure preferably has a ratio (Dv/Dn) of the volume average particle diameter (Dv) to the number average particle diameter (Dn) of from 1.0 to 1.3, and more preferably from 1.0 to 1.2. When the Dv/Dn of the toner is 1.3 or less, it is possible to suppress a deterioration in the transfer property of the toner and a decrease in image density and image resolution. The volume average particle diameter and number average particle diameter of the toner can be measured using a particle size analyzer (product name: MULTISIZER; manufactured by: Beckman Coulter, Inc.) or the like.

The average circularity of the toner of the second present disclosure is preferably from 0.96 to 1.00, more preferably from 0.97 to 1.00, and still more preferably from 0.98 to 1.00, from the viewpoint of image reproducibility.

When the average circularity of the toner is 0.96 or more, fine line reproducibility of printing can be improved.

For example, the circularity of the toner can be determined as follows. An aqueous solution in which the toner is dispersed, is used as a sample solution, and the projected image of the toner particles in the sample solution is taken by means of a flow type particle image analyzer (e.g., product name: FPIA-2100, manufactured by: Sysmex Corporation). The perimeter of the circle having the same area as the projected area of the toner particle image, and the perimeter of the projected toner particle image are measured from the projected image, and the circularity of the toner is obtained by the following calculation formula 1: (Circularity)=(Perimeter of the circle having the same area as the projected area of the particle image) (Perimeter of the projected particle image). The average circularity is the average value of the circularities of the toner particles contained in the sample solution.

The presence or absence of the external additive does not cause a significant difference in the values of the volume average particle diameter (Dv), number average particle diameter (Dn) and average circularity of the toner. Accordingly, the values of the volume average particle diameter (Dv), number average particle diameter (Dn) and average circularity of the toner which contains the external additive, can be deemed identical to those of the colored resin particles which does not contain the external additive.

The toner of the second present disclosure is a toner such that the occurrence of spouting of the toner when enduring in a high temperature and high humidity environment is suppressed. After an endurance test in which the toner of the second present disclosure is left to stand for 24 hours in a high temperature and high humidity environment and continuous printing is carried out on up to 5000 sheets of paper at an image density of 5% in the same environment, it is preferable that the toner does not spout from the developing roller of a cartridge, and it is more preferable that when the cartridge is tilted after the endurance test, the toner spouts from only a part of the developing roller or it does not spout from the developing roller.

The description of the test for spouting of the toner when enduring in a high temperature and high humidity environment, is the same as that described in the first present disclosure.

The toner of the second present disclosure is a toner which has good storage stability and in which a decrease in the blocking occurrence temperature (heat resistant temperature) is suppressed. The blocking occurrence temperature (heat resistant temperature) of the toner of the second present disclosure is preferably 54° C. or higher, more preferably 55° C. or higher, and still more preferably 56° C. or higher. The definition of the blocking occurrence temperature and the description of the measurement method are the same as that described in the first present disclosure.

The toner of the second present disclosure has good low-temperature fixability. When a solid image is printed on a sheet using a printer in which the temperature of the fixing roller is set to 150° C., and a rubbing test is carried out on the solid area, the density decrease ratio of the toner is preferably 30% or less, more preferably 25% or less, and still more preferably 20% or less. The description of the method for obtaining the density decrease ratio is the same as that described in the first present disclosure.

### EXAMPLES

Hereinafter, the present disclosure will be described further in detail, with reference to Examples and Comparative Examples. Examples relating to the toner of the first present disclosure will be described as Example I series, and examples relating to the toner of the second present disclosure will be described as Example II series. However, the present disclosure is not limited to these examples. Herein, part(s) and % are on a mass basis unless otherwise noted.

The weight average molecular weight Mw of the polymer was determined as a polystyrene equivalent molecular weight measured by GPC. A sample for measurement was obtained as follows: a polymer was dissolved in tetrahydrofuran (THE) so as to have a concentration of 2 mg/mL, and an ultrasonic treatment was carried out thereon for 10 minutes, followed by filtration through a 0.45 μm membrane filter, thereby obtaining the sample for measurement. The measurement conditions were as follows: temperature: 40° C., solvent: tetrahydrofuran, flow rate: 1.0 mL/min, concentration: 0.2 wt. %, and sample input amount: 100 μL. As a column, GPC TSKGEL MULTIPORE HXL-M (30 cm×2) manufactured by Tosoh Corporation, was used. Also, the measurement was carried out under the condition that the first-order correlation (Log (Mw)−elution time) in a weight average molecular weight (Mw) range of from 1,000 to 300,000, was 0.98 or more. The weight average molecular weight Mw of the polymer contained in the binder resin of the toner was obtained as follows: a sample was obtained by dissolving the toner in THE, and the weight average molecular weight Mw of the binder resin was determined using data obtained by subtracting the peaks of the charge control resin and the softening agent measured in advance from the results of GPC obtained by the aforementioned measurement method. In Table 1. for simplicity, the exponent notation defined in JIS X 0210 is used to express the value of the weight average molecular weight Mw. For example, “5.04×10⁵” is expressed as “5.04 E+05”.

### EXAMPLE I SERIES

### Example I-1

1. Production of colored resin particles

### 1-1. Preparation of Polymerizable Monomer Composition for Core

First, as the binder resin, 72 parts of styrene, 28 parts of n-butyl acrylate, 0.1 parts of a polymethacrylic acid ester macromonomer (product name: AA-6; manufactured by: TOAGOSEI Co., Ltd.; Tg: 94° C.) and 0.71 parts of divinylbenzene, as a molecular weight modifier, 1.25 parts of tetraethyl thiuram disulfide, and as a colorant, 7 parts of C.I. Pigment Yellow 155 (product name: TONER YELLOW 3GP CT, manufactured by: Clariant) were wet-pulverized by means of a media-type disperser (product name: PICOMILL, manufactured by: ASADA IRON WORKS. Co., Ltd.)

To the mixture obtained by the wet-pulverization, 0.8 parts of a charge control resin (a styrene-acrylic resin containing a quaternary ammonium salt, product name: ACRYBASE (registered trademark) FCA-161P, manufactured by: Fujikura Kasei Co., Ltd., functional group amount: 8% by mass) and 6.0 parts of a synthetic ester wax (pentaerythritol tetrabehenate, melting point: 76° C.) were added, mixed and dissolved to prepare a polymerizable monomer composition for core.

### 1-2. Preparation of Aqueous Dispersion Medium

An aqueous solution in which 7.3 parts of sodium hydroxide was dissolved in 50 parts of deionized water, was gradually added under stirring to an aqueous solution in which 10.4 parts of magnesium chloride was dissolved in 280 parts of deionized water, thereby preparing a magnesium hydroxide colloidal dispersion.

### 1-3. Preparation of Polymerizable Monomer for Shell

An aqueous dispersion of a polymerizable monomer for shell was prepared by finely dispersing 2 parts of methyl methacrylate and 130 parts of water by means of an ultrasonic emulsifier.

### 1-4. Droplets Forming Step

The polymerizable monomer composition for core was added to the magnesium hydroxide colloidal dispersion (the magnesium hydroxide colloid amount: 5.3 parts), and the mixture was further stirred. Then, as a polymerization initiator, 6 parts of t-butylperoxy-2-ethylbutanoate was added thereto. The dispersion mixed with the polymerization initiator was dispersed at a rotational frequency of 15,000 rpm by an in-line type emulsifying and dispersing machine (product name: MILDER, manufactured by: Pacific Machinery & Engineering Co., Ltd.) to form droplets of the polymerizable monomer composition for core.

### 1-5. Polymerization Step

The dispersion containing the droplets of the polymerizable monomer composition for core was placed in a reactor, and the temperature of the dispersion was raised to 90° C. to initiate a polymerization reaction. After reaching the polymerization conversion rate of almost 100%, a solution prepared by dissolving, as a polymerization initiator for shell, 0.1 parts of 2,2′-azobis [2-methyl-N-(2-hydroxyethyl)-propionamide] (product name: VA-086, manufactured by: Wako Pure Chemical Industries, Ltd., a water-soluble initiator) in the aqueous dispersion of the polymerizable monomer for shell, was added to the reactor. Next, the polymerization reaction was further continued by maintaining the dispersion temperature at 95° C. for 4 hours. Then, the polymerization reaction was stopped by water cooling, thereby obtaining an aqueous dispersion of core-shell type colored resin particles.

### 1-6. Washing, Filtering and Dehydrating Step

The aqueous dispersion of the colored resin particles was subjected to acid washing (25° C., 10 minutes) by adding, while stirring the aqueous dispersion, sulfuric acid to the dispersion until the pH of the dispersion reached 4.5 or less. Then, the colored resin particles were separated by filtration and washed with water. The washing water was filtered. The electric conductivity of the filtrate at this time was 20 μS/cm. The colored resin particles subjected to the washing and filtering were dehydrated to obtain the colored resin particles in a wet state.

### 1-7. Volume Average Particle Diameter (Dv)

About 0.1 g of the colored resin particles obtained in “1-6. Washing, filtering and dehydrating step” were weighed out and put in a beaker. Next, as a dispersant, 0.1 mL of a surfactant aqueous solution (product name: DRIWEL, manufactured by: Fujifilm Corporation) was added thereto. In addition, 10 mL to 30 mL of ISOTON II was put in the beaker. The mixture was dispersed for 3 minutes with a 20 W (watt) ultrasonic disperser. Then, the volume average particle diameter (Dv) of the colored resin particles was measured with a particle size analyzer (product name: MULTISIZER, manufactured by: Beckman Coulter, Inc.) in the following conditions: aperture diameter: 100 μm, medium: ISOTON II, and the number of measured particles: 100,000 particles.

### 1-8. Moisture Content

About 1 g of the colored resin particles obtained in “1-6. Washing, filtering and dehydrating step” were precisely weighed to 0.1 mg (w1). The colored resin particles were placed in a dryer at 105° C. (the temperature error of each part: 1° C. or less) and dried for one hour. After cooling the dried colored resin particles, the colored resin particles were precisely weighed again (w2). Using the measured values, the moisture content was calculated by the following formula.

$$Moisture content ( \% ) = [ ( w 1 - w 2 ) / w 1 ] \times 100$$

### 2. Production of Toner

### 2-1. First Step of External Addition Treatment

The colored resin particles in a wet state obtained in “1-6. Washing, filtering and dehydrating step” was collected so that the content of the binder resin in the colored resin particles was 100 parts by mass. To the collected wet colored resin particles, 0.20 parts of hydrophobized silica fine particles having a number average primary particle diameter of 7 nm (product name: TG-820F, manufactured by: Cabot Corporation) were added as the inorganic fine particles C. Then, the particles were put in a mixing device (product name: LABOMIXER, model: LV-1, manufactured by: Hosokawa Micron Corporation) placed in a constant temperature and humidity room in an environment at 35° C. While mixing the particles at 180 rpm, they were dried for 24 hours, thereby obtaining intermediate particles.

### 2-2. Second Step of External Addition Treatment

To the intermediate particles, the following particles were added.

Inorganic fine particles A: 1.33 parts of hydrophobized silica fine particles having a number average primary particle diameter of 50 nm (product name: H05TA, manufactured by: Clariant Corporation)

Inorganic fine particles B: 0.53 parts of hydrophobized silica fine particles having a number average primary particle diameter of 20 nm (product name: TG-7120, manufactured by: Cabot Corporation)

Inorganic fine particles C: 0.20 parts of hydrophobized silica fine particles having a number average primary particle diameter of 7 nm (product name: TG-820F, manufactured by: Cabot Corporation)

Organic fine particles D: 0.13 parts of fatty acid metal salt particles having a number average primary particle diameter of 0.5 μm (product name: SPZ-100F, zinc stearate particles manufactured by: Sakai Chemical Industry Co., Ltd.)

They were mixed by means of a high-speed stirring machine (product name: FM MIXER, manufactured by: Nippon Coke & Engineering Co., Ltd.) in the following conditions, thereby preparing the toner of Example I-1.

Peripheral speed of the stirring blades: 46.6 m/s

External addition treatment time: 8.0 min

### Example I-2

The toner of Example I-2 was obtained in the same manner as Example I-1, except that in “2. Production of toner”, the amount of the added organic fine particles D (SPZ-100F) was changed according to Table 1 shown below.

### Examples I-3 to I-6

The toners of Examples I-3 to I-6 were obtained in the same manner as Example I-1, except that in “1-1. Preparation of polymerizable monomer composition for core” of “1. Production of colored resin particles”, the amount of the added divinylbenzene (DVB) was changed according to Table 1 shown below; in “2. Production of toner”, the inorganic fine particles C (TG-820F) were not added in the second step of the external addition treatment; and the amounts of the external additives added in the second step of the external addition treatment, were changed according to Table 1 shown below.

### Example I-7

The toner of Example I-7 was obtained in the same manner as Example I-1, except that in “1-1. Preparation of polymerizable monomer composition for core” of “1. Production of colored resin particles”, the type of the added colorant was changed according to Table 1 shown below.

### Example I-8

The toner of Example I-8 was obtained in the same manner as Example I-1, except that in “2. Production of toner”, the type of the added organic fine particles D (fatty acid metal salt particles) was changed according to Table 1 shown below.

### Example I-9

The toner of Example I-9 was obtained in the same manner as Example I-1, except that in “1-1. Preparation of polymerizable monomer composition for core” of “1. Production of colored resin particles”, the amount of the added divinylbenzene (DVB) and the amount of the added charge control resin (product name: ACRYBASE (registered trademark) FCA-161P) were changed according to Table 1 shown below; in “2. Production of toner”, the inorganic fine particles C (TG-820F) were not added in the second step of the external addition treatment; and the amounts of the external additives added in the second step of the external addition treatment, were changed according to Table 1 shown below.

### Comparative Example I-1

The toner of Comparative Example I-1 was obtained in the same manner as Example I-1, except that in “2. Production of toner”, the organic fine particles D (SPZ-100F) were not added.

### Comparative Example I-2

The toner of Comparative Example I-2 was obtained in the same manner as Example I-1, except that in “1-1. Preparation of polymerizable monomer composition for core” of “1. Production of colored resin particles”, the materials used were changed according to Table 2 shown below; in “2. Production of toner”, the inorganic fine particles C (TG-820F) were not added in the second step of the external addition treatment; and the amounts of the added external additives were changed according to Table 2 shown below.

### Comparative Examples I-3 to I-5

The toners of Comparative Examples I-3 to I-5 were obtained in the same manner as Example I-1, except for the following.

In “1-1. Preparation of polymerizable monomer composition for core” of “1. Production of colored resin particles”, the materials used were changed according to Table 2 shown below.

In “2. Production of toner”, the inorganic fine particles C (TG-820F) were not added in the first step of the external addition treatment, and only the colored resin particles were subjected to mixing, stirring and drying.

Also in “2. Production of toner”, the external additives added in the second step of the external addition treatment were changed according to Table 2, and the peripheral speed of the stirring blades in the external addition treatment and the external addition treatment time were changed according to Table 2 shown below.

### [Measurement of Viscoelasticity]

For the toner obtained in each of Examples and Comparative Examples, the temperature dependence curve for the loss tangent (tan δ) was obtained by dynamic viscoelasticity measurement. The dynamic viscoelasticity measurement was carried out using a rotating flat plate rheometer (product name: ARES-G2, manufactured by: TA Instruments Inc.) and a cross-hatch plate under the conditions mentioned below. A test piece was produced by pouring 0.2 g of the toner into a cylindrical mold of 8 mm φ and pressurizing the toner at 1.0 MPa for 30 seconds, thereby forming a columnar molded product having a diameter of 8 mm φ and a thickness of 3 mm.

### (Conditions of the Dynamic Viscoelasticity Measurement)

Frequency: 24 Hz
Sample set: A test piece (3 mm thick) was sandwiched between 8 mm φ plates with a 20 g load; the test piece was fused to a jig by increasing the temperature to 80° C.; the temperature was returned to 45° C.; then, increasing the temperature (temperature increase) was started.
Temperature increase rate: 5° C./min
Temperature range: 45° C. to 190° C.

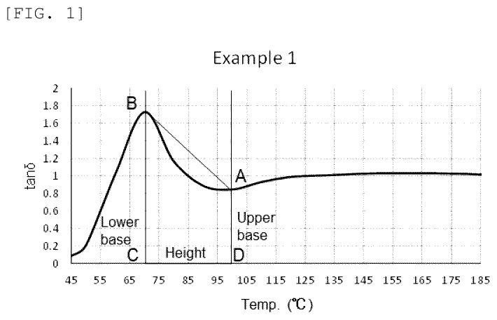

The shape of the temperature dependence curve for the loss tangent (tan δ) of the toner obtained in each Example had the following characteristics. In the temperature range of from 45° C. to the glass transition temperature (Tg) shown in Table 1, with increasing temperature, the tan δ rapidly increased from around 0 to around 1.8, and the tan δ reached at the maximum value at the Tg. In the temperature range of from the Tg to around 100° C., the tan δ decreased with increasing temperature to around 0.8 to 0.9 at around 100° C., and reached the minimum value. In the temperature range of from the temperature at the minimum value of the tan δ to 190° C., the tan δ gradually increased with increasing temperature, then became a substantially constant value. As an example, the temperature dependence curve for the loss tangent (tan δ) of the toner obtained in Example I-1 is shown in FIG. 1.

Further, for each toner, from the obtained temperature-tan δ curve, the glass transition temperature (Tg), the loss tangent (tan δ) at the glass transition temperature (Tg) (that is, tan δ (Tg)), and the loss tangent (tan δ) at 100° C. (that is, tan δ (100° C.)) were determined, and the area of the trapezoid where the upper base, the lower base and the height were the value of tan δ (100° C.), the value of tan δ (Tg) and the value of 100−Tg, respectively, was calculated. The trapezoid specified from the temperature-tan δ curve shown in FIG. 1 is the trapezoid ABCD shown in FIG. 1. In the temperature-tan δ curve, the point of tan δ (100° C.) is the point A; the point of tan δ (Tg) is the point B; the intersection where the perpendicular from the point A to the horizontal axis (tan δ=0) intersects the horizontal axis, is the point D; and the intersection where the perpendicular from the point B to the horizontal axis (tan δ=0) intersects the horizontal axis, is the point C.

### [Measurement of Flowability]

Three kinds of sieves having different opening sizes (150 μm, 75 μm and 45 μm) were stacked in this order from top to bottom. Next, 4 g of the toner was weighed as precisely as possible and placed on the top sieve. Then, the stacked three sieves were oscillated for 15 seconds at an amplitude of 0.30 mm, using a powder characteristic tester (product name: POWDER TESTER (registered trademark), model: PT-X, manufactured by: Hosokawa Micron Corporation). Then, the weight of the toner remaining on each sieve was measured. The measured values were plugged into the following calculation formula 1 to obtain the values of a, b and c. Next, the a, b and c values were plugged into the calculation formula 2 to calculate the value of the flowability in percentage. Each sample was measured three times, and the average was determined as the value of the flowability of the toner.

$$a = [ ( Weight ( g ) of the toner remaining on the 150 μ m sieve ) / 4 g ] \times 100 \qquad Calculation formula 1 :$$

$$b = [ \text{} ( Weight ( g ) of the toner remaining on the 75 μ m sieve ) / 4 g ] \times 100 \times 0.6$$

$$c = [ \text{} ( Weight ( g ) of the toner remaining on the 45 μ m sieve ) / 4 g ] \times 100 \times 0.2$$

$$Flowability ( \% ) = 100 - ( a + b + c ) \qquad Calculation formula 2 :$$

### [Measurement of CBD]

The following measurement was carried out by use of a powder flowability analyzing device (product name: FT4 POWDER RHEOMETER, manufactured by: Freeman Technology).

As a conditioning container, such a container was used, that an ancillary container (inner diameter: 50 mm, volume: 85 mL) was placed on the top of a measurement container (inner diameter: 50 mm, volume: 160 mL) furnished with a clamp and connected thereto by a splitter.

The conditioning of the toner was carried out by a method in which, following the first step described below, a series of the second to fifth steps described below were carried out for 3 cycles.

### (First Step)

First, 100 g of the toner was packed in the conditioning container and left to stand for 10 minutes as it was, thereby forming a toner layer. The amount of the packed toner was such an amount, that the packed toner exceeded the capacity of the measurement container.

### (Second Step)

The measurement container was set in an analyzing device furnished with propeller-shaped blades. The tip speed and entry angle of the blades were set to the following speed and angle. With stirring the toner layer, the blades were inserted into the toner layer from the surface of the toner layer, until it reached a position 10 mm above the bottom of the measurement container.
Tip speed of the blades: 60 mm/sec
Entry angle of the blades: 5° in clockwise direction

### (Third Step)

The entry angle of the blades was changed to 2° in clockwise direction, without changing the tip speed of the blades. While stirring the toner layer, the blades were moved down to a position 1 mm above the bottom of the measurement container.

### (Forth Step)

The entry angle of the blades was changed to 5° in anticlockwise direction, without changing the tip speed of the blades. While stirring the toner layer, the blades were moved up to a position 100 mm above the bottom of the measurement container.

### (Fifth Step)

The blades were raised from the toner layer surface.

When the second step was carried out after the fifth step, the blades were raised from the toner layer surface in the fifth step and rotated small in clockwise direction and anticlockwise direction, alternately, thereby shaking off excess toner attached to the blades. Then, the second step was carried out.

After the conditioning of the toner, the ancillary container was detached and, at the same time, the toner above the edge of the measurement container was leveled off by the splitter, thereby producing a toner cake having the same volume as the measurement container.

The value calculated by dividing the mass of the obtained toner cake by the volume of the measurement container, was determined as the conditioned bulk density (CBD, g/mL).

### [Measurement of BET Specific Surface Area]

The BET specific surface area of each toner was measured by a nitrogen adsorption method (BET method) using a full automatic BET specific surface area measuring device (product name: MACSORB HM MODEL-1203, manufactured by: Mountech Co., Ltd.)

### [Evaluation]

### (1) Heat Resistant Temperature of the Toner

First, 10 g of the toner was placed in a 100 mL polyethylene container, and the container was hermetically sealed. Then, the container was set in a constant temperature water bath at a predetermined temperature that was set by changing the bath temperature 1° C. by 1° C. from 50° C. After 8 hours passed, the container was removed from the constant temperature water bath. The toner was transferred from the removed container onto a 42-mesh sieve in a manner preventing vibration as much as possible, and then it was set in a powder characteristic tester (product name: POWDER TESTER (registered trademark) PT-R, manufactured by: Hosokawa Micron Corporation). The amplitude condition of the sieve was set to 1.0 mm, and the sieve was vibrated for 30 seconds. Then, the mass of the toner remaining on the sieve was measured, and the thus-measured mass was determined as an aggregated toner mass.

The maximum temperature at which the aggregated toner mass became 0.5 g or less, was determined as the heat resistant temperature of the toner. As the heat resistant temperature increases, the blocking during toner storage is less likely to occur and the toner becomes more excellent in storage stability.

### (2) Density Decrease Ratio of the Toner

A commercially-available, non-magnetic one-component developing printer was modified such that the temperature of the fixing roller was able to be changed. The temperature of the fixing roller of the printer was set to 150° C., and solid pattern printing (image density 100%) was carried out using the printer. Then, a rubbing test was carried out on the solid area; the image density of the solid area was measured before and after the rubbing test; and the density decrease ratio was calculated. The lower the density decrease ratio, the better the low-temperature fixability of the toner.

When the image density before the rubbing test is determined as “ID (before)” and the image density after the rubbing test is determined as “ID (after)”, the density decrease ratio is determined as follows:

$$Density decrease ratio ( \% ) = \{ [ ID ( before ) - ID ( after ) ] / ID ( before ) \} \times 100.$$

The rubbing test was carried out by attaching the measurement area of a test paper sheet to a fastness tester with an adhesive tape, applying a 500 g load, and carrying out reciprocating rubbing 5 times with a rubbing terminal wrapped with a cotton cloth.

(3) Test for Spouting of the Toner when Enduring in a High Temperature and High Humidity Environment

Using a commercially-available, non-magnetic one-component development printer (HL-3040CN), the toner was packed in the toner cartridge of the developing device of the printer. Then, printing sheets were loaded in the printer. An endurance test was carried out, in which the printer was left to stand for 24 hours in a high temperature and high humidity (H/H) environment (temperature: 35° C., humidity: 80% RH) and continuous printing was carried out on up to 5000 sheets at an image density of 5% in the same environment. After the test, it was checked whether or not a phenomenon in which the toner spouted from the developing roller of the cartridge, occurred, and evaluation was conducted based on the following evaluation criteria.

### (Evaluation Criteria for Toner Spouting)

0: The toner did not spout from the developing roller when the cartridge was or was not tilted.
1: The toner did not spout from the developing roller when the cartridge was not in a tilted state; however, the toner spouted from a part of the developing roller when the cartridge was tilted.
2: The toner spouted from a part of the developing roller even when the cartridge was not tilted.
3: The toner spouted from the whole surface of the developing roller even when the cartridge was not tilted.

TABLE 1

| | | | Example I-1 | Example I-2 | Example I-3 | Example I-4 |
|---|---|---|---|---|---|---|
| Colored | Binder resin | ST (parts) | 72 | 72 | 72 | 72 |
| resin | | BA (parts) | 28 | 28 | 28 | 28 |
| particles | | DVB (parts) | 0.71 | 0.71 | 0.69 | 0.69 |
| | | AA6 (parts) | 0.1 | 0.1 | 0.1 | 0.1 |
| | | Mw | 5.04E+05 | 5.04E+05 | 4.93E+05 | 4.93E+05 |
| | | TET (Molecular weight | 1.25 | 1.25 | 1.25 | 1.25 |
| | | modifier) (parts) | | | | |
| | Charge control | 161P (parts) | 0.8 | 0.8 | 0.8 | 0.8 |
| | resin | | | | | |
| | Colorant | PY155 (parts) | 7 | 7 | 7 | 7 |
| | | PB15:3 (parts) | 0 | 0 | 0 | 0 |
| | | CB (parts) | 0 | 0 | 0 | 0 |
| | Dv (μm) | | 7.0 | 7.0 | 7.1 | 7.1 |
| | Moisture content (%) | | 10 | 10 | 8 | 8 |
| External | Silica fine | TG820F (parts) | 0.40 | 0.40 | 0.20 | 0.20 |
| additive | particles | TG7120 (parts) | 0.53 | 0.53 | 0.53 | 0.53 |
| | | H05TA (parts) | 1.33 | 1.33 | 1.32 | 1.32 |
| | Fatty acid metal | SPZ-100F (parts) | 0.13 | 0.05 | 0.13 | 0.04 |
| | salt particles | SPX-100F (parts) | 0.00 | 0.00 | 0.00 | 0.00 |
| External | Treatment method | | Two-step | Two-step | Two-step | Two-step |
| addition | | | treatment | treatment | treatment | treatment |
| treatment | Peripheral speed (m/s) of stirring blades | | 46.6 | 46.6 | 46.6 | 46.6 |
| | External addition treatment time (min) | | 8.0 | 8.0 | 8.0 | 8.0 |
| Toner | Viscoelasticity | Tanδ(100° C.) | 0.84 | 0.85 | 0.92 | 0.92 |
| | | tanδ(Tg) | 1.73 | 1.71 | 1.80 | 1.80 |
| | | Tg | 69.3 | 69.5 | 69.9 | 70.3 |
| | | Area of trapezoid (° C.) | 39.4 | 39.1 | 40.9 | 40.4 |
| | Flowability (%) | (Amplitude 0.3 mm) | 97 | 97 | 81 | 87 |

| | | | | |
|---|---|---|---|---|
| CBD (g/mL) | 0.549 | 0.550 | 0.537 | 0.540 |
| BET specific surface area (m²/g) | 1.71 | 1.73 | 1.81 | 1.85 |
| Heat resistant temperature (° C.) | 57 | 57 | 57 | 57 |
| Density decrease ratio (%) | 29 | 23 | 13 | 12 |
| Spouting when enduring in high | 1 | 1 | 0 | 0 |
| temperature and high humidity environment | | | | |

| | | | Example I-5 | Example I-6 | Example I-7 | Example I-8 | Example I-9 |
|---|---|---|---|---|---|---|---|
| Colored | Binder resin | ST (parts) | 72 | 72 | 72 | 72 | 72 |
| resin | | BA (parts | 28 | 28 | 28 | 28 | 28 |
| particles | | DVB (parts) | 0.69 | 0.69 | 0.71 | 0.71 | 0.69 |
| | | AA6 (parts) | 0.1 | 0.1 | 0.1 | 0.1 | 0.1 |
| | | Mw | 4.93E+05 | 4.74E+05 | 4.90E+05 | 5.04E+05 | 4.96E+05 |
| | | TET (Molecular weight | 1.25 | 1.25 | 1.25 | 1.25 | 1.25 |
| | | modifier) (parts) | | | | | |
| | Charge control | 161P (parts) | 0.8 | 0.8 | 0.8 | 0.8 | 0.97 |
| | resin | | | | | | |
| | Colorant | PY155 (parts) | 7 | 7 | 0 | 7 | 7 |
| | | PB15:3 (parts) | 0 | 0 | 7 | 0 | 0 |
| | | CB (parts) | 0 | 0 | 0 | 0 | 0 |
| | Dv (μm) | | 7.1 | 7.0 | 7.0 | 7.0 | 7.1 |
| | Moisture content (%) | | 8 | 8 | 7 | 10 | 8 |
| External | Silica fine | TG820F (parts) | 0.20 | 0.20 | 0.40 | 0.40 | 0.20 |
| additive | particles | TG7120 (parts) | 0.53 | 0.54 | 0.53 | 0.53 | 0.53 |
| | | H05TA (parts) | 1.32 | 1.35 | 1.33 | 1.33 | 1.32 |
| | Fatty acid metal | SPZ-100F (parts) | 0.09 | 0.14 | 0.13 | 0.00 | 0.13 |
| | salt particles | SPX-100F (parts) | 0.00 | 0.00 | 0.00 | 0.13 | 0.00 |
| External | Treatment method | | Two-step | Two-step | Two-step | Two-step | Two-step |
| addition | | | treatment | treatment | treatment | treatment | treatment |
| treatment | Peripheral speed (m/s) of stirring blades | | 46.6 | 46.6 | 46.6 | 46.6 | 46.6 |
| | External addition treatment time (min) | | 8.0 | 8.0 | 8.0 | 8.0 | 8.0 |
| Toner | Viscoelasticity | Tanδ(100° C.) | 0.91 | 0.95 | 0.92 | 0.86 | 0.90 |
| | | tanδ(Tg) | 1.78 | 1.86 | 1.82 | 1.80 | 1.74 |
| | | Tg | 69.9 | 70.2 | 67.7 | 70.2 | 69.7 |
| | | Area of trapezoid (° C.) | 40.5 | 41.8 | 44.2 | 39.6 | 40.0 |
| | Flowability (%) | (Amplitude 0.3 mm) | 85 | 81 | 94 | 82 | 86 |

| | | | | | |
|---|---|---|---|---|---|
| CBD (g/mL) | 0.537 | 0.529 | 0.540 | 0.527 | 0.543 |
| BET specific surface area (m²/g) | 1.86 | 1.85 | 1.72 | 1.74 | 1.80 |
| Heat resistant temperature (° C.) | 57 | 57 | 56 | 57 | 56 |
| Density decrease ratio (%) | 11 | 5 | 25 | 28 | 9 |
| Spouting when enduring in high | 0 | 0 | 1 | 1 | 0 |
| temperature and high humidity | | | | | |
| environment | | | | | |

TABLE 2

| | | | Comparative | Comparative | Comparative | Comparative | Comparative |
|---|---|---|---|---|---|---|---|
| | | | Example I-1 | Example I-2 | Example I-3 | Example I-4 | Example I-5 |
| Colored | Binder resin | ST (parts) | 72 | 81 | 72 | 81 | 77 |
| resin | | BA (parts) | 28 | 19 | 28 | 19 | 23 |
| particles | | DVB (parts) | 0.71 | 0.69 | 0.71 | 0.69 | 0.78 |
| | | AA6 (parts) | 0.1 | 0.1 | 0.1 | 0.1 | 0.25 |
| | | Mw | 5.04E+05 | 4.32E+05 | 5.04E+05 | 4.32E+05 | 4.21E+05 |
| | | TET (Molecular weight | 1.25 | 1.60 | 1.25 | 1.60 | 1.50 |
| | | modifier) (parts) | | | | | |
| | Charge control | 161P (parts) | 0.8 | 0.8 | 0.5 | 1.0 | 1.6 |
| | resin | | | | | | |
| | Colorant | PY155 (parts) | 7 | 7 | 7 | 7 | 0 |
| | | PB15:3 (parts) | 0 | 0 | 0 | 0 | 0 |
| | | CB (parts) | 0 | 0 | 0 | 0 | 7 |
| | Dv (μm) | | 7.0 | 7.0 | 7.0 | 7.0 | 6.5 |
| | Moisture content (%) | | 10 | 10 | 10 | 11 | 14 |
| External | Silica fine | TG820F (parts) | 0.40 | 0.20 | 0.40 | 0.20 | 0.10 |
| additive | particles | TG7120 (parts) | 0.50 | 0.54 | 0.50 | 0.54 | 0.08 |
| | | H05TA (parts) | 1.42 | 1.35 | 1.42 | 1.35 | 0.20 |
| | Fatty acid | SPZ-100F (parts) | 0.00 | 0.13 | 0.00 | 0.13 | 0.20 |
| | metal salt | SPX-100F (parts) | 0.00 | 0.00 | 0.00 | 0.00 | 0.00 |
| | particles | | | | | | |
| External | Treatment method | | Two-step | Two-step | One-step | One-step | One-step |
| addition | | | treatment | treatment | treatment | treatment | treatment |
| treatment | Peripheral speed (m/s) of stirring | | 46.6 | 46.6 | 46.6 | 38.2 | 30.0 |
| | blades | | | | | | |
| | External addition treatment time (min) | | 8.0 | 8.0 | 8.0 | 15.0 | 6.0 |
| Toner | Viscoelasticity | tanδ(100° C.) | 0.88 | 1.05 | 0.88 | 1.05 | 1.27 |
| | | tanδ(Tg) | 1.74 | 2.43 | 1.74 | 2.43 | 2.70 |
| | | Tg | 69.8 | 80.7 | 69.8 | 80.7 | 75.7 |
| | | Area of trapezoid (° C.) | 39.6 | 33.6 | 39.6 | 33.6 | 48.1 |
| | Flowability (%) | (Amplitude 0.3 mm) | 87 | 81 | 78 | 77 | 73 |

| | | | | | |
|---|---|---|---|---|---|
| CBD (g/mL) | 0.551 | 0.533 | 0.540 | 0.530 | 0.507 |
| BET specific surface area (m²/g) | 1.82 | 1.85 | 1.90 | 2.14 | 0.98 |
| Heat resistant temperature (° C.) | 57 | 57 | 58 | 59 | 50 |
| Density decrease ratio (%) | 25 | 45 | 20 | 55 | 5 |
| Spouting when enduring in high | 3 | 0-1 | 3 | 2 | 3 |
| temperature and high humidity | | | | | |
| environment | | | | | |

Abbreviations in Tables 1 and 2 are as follows.
ST: Styrene
BA: n-Butyl acrylate
DVB: Divinylbenzene
AA6 Polymethacrylic acid ester macromonomer (product name: AA6; manufactured by: TOAGOSEI Co., Ltd.; Tg: 94° C.)
TET: Tetraethyl thiuram disulfide
161P: Styrene-acrylic resin containing a quaternary ammonium salt (product name: ACRYBASE FCA-161P, manufactured by: Fujikura Kasei Co., Ltd., functional group amount: 8% by mass)
PY155: C.I. Pigment Yellow 155
PB15:3: C.I. Pigment Blue 15:3
CB: Carbon black
TG820F: Hydrophobized silica fine particles having a number average primary particle diameter of 7 nm (product name: TG-820F, manufactured by: Cabot Corporation)
TG7120: Hydrophobized silica fine particles having a number average primary particle diameter of 20 nm (product name: TG-7120, manufactured by: Cabot Corporation)
H05TA: Hydrophobized silica fine particles having a number average primary particle diameter of 50 nm (product name: H05TA, manufactured by: Clariant Corporation)
SPZ-100F: Fatty acid metal salt particles having a number average primary particle diameter of 0.5 μm (product name: SPZ-100F, zinc stearate particles manufactured by: Sakai Chemical Industry Co., Ltd.)
SPX-100F: Fatty acid metal salt particles having a number average primary particle diameter of 0.72 μm (product name: SPX-100F, magnesium stearate particles manufactured by: Sakai Chemical Industry Co., Ltd.)

Also in Tables 1 and 2, the case of carrying out the external addition treatment in two steps is described that the treatment method of the external addition treatment is two-step treatment, and the case of carrying out the external addition treatment in one step is described that the treatment method of the external addition treatment is one-step treatment.

### [Consideration]

As for the toner of Comparative Example I-1, the CBD was more than 0.550 g/mL. Accordingly, when the endurance test was carried out in the high temperature and high humidity environment, the toner of Comparative Example I-1 spouted from the whole surface of the developing roller.

As for the toner of Comparative Example I-2, the Tg was more than 75.0° C., and the area of the trapezoid was less than 35.0. Accordingly, the density decrease ratio of the solid area before and after the rubbing test was high, that is, the toner of Comparative Example I-2 was poor in low-temperature fixability.

As for the toner of Comparative Example I-3, the flowability was less than 80%. Accordingly, when the endurance test was carried out in the high temperature and high humidity environment, the toner of Comparative Example I-3 spouted from the whole surface of the developing roller. The toner of Comparative Example 1-3 was produced by use of similar materials and steps to Example I series of Patent Document 1.

As for the toner of Comparative Example I-4, the Tg was more than 75.0° C.; the area of the trapezoid was less than 35.0; and the flowability was less than 80%. Accordingly, the density decrease ratio of the solid area before and after the rubbing test was high, that is, the toner of Comparative Example I-4 was poor in low-temperature fixability. When the endurance test was carried out in the high temperature and high humidity environment, the toner of Comparative Example I-4 was spouted from a part of the developing roller. The toner of Comparative Example I-4 was produced by use of similar materials and steps to Examples of Patent Document 2.

As for the toner of Comparative Example I-5, the area of the trapezoid was more than 48.0; the flowability was less than 80%; and the CBD was less than 0.527 g/mL. Accordingly, the toner was poor in storage stability due to the low heat resistant temperature, that is, easy occurrence of blocking during toner storage. Moreover, in the endurance test carried out in a high temperature and high humidity environment, the toner of Comparative Example 1-5 spouted from the whole surface of the developing roller.

As for the toners of Examples I-1 to I-9, the glass transition temperature (Tg) specified from the temperature-tan δ curve at a measurement frequency of 24 Hz satisfied 65.0° C.≤Tg (C)≤75.0° C.; the area of the trapezoid where the upper base, the lower base and the height were the value of tan δ (100° C.), the value of tan δ (Tg) and the value of 100−Tg, respectively, was 35.0 or more and 48.0 or less; the CBD was 0.527 g/mL or more and 0.550 g/mL or less; and the flowability was 80% or more. Accordingly, the toners of Examples I-1 to 1-9 were excellent in storage stability due to the high heat resistant temperature, that is, hardly occurrence of blocking during toner storage; the density decrease ratio of the solid area before and after the rubbing test was high, that is, the toners of Examples I-1 to I-9 were excellent in low-temperature fixability; and the toners did not spout even when the endurance test was carried out in the high temperature and high humidity environment, that is, the toners of Examples I-1 to I-9 were toners such that the spouting of the toners when enduring in the high temperature and high humidity environment, was suppressed.

### EXAMPLE II SERIES

### Example II-1

The toners of Examples II-1 to II-8 were obtained in the same manner as Examples I-1 to I-8 of Example I series.

### Comparative Example II-1

The toner of Comparative Example II-1 was obtained in the same manner as Example II-3 (the same as Example 1-3), except that in “2. Production of toner”, the fatty acid metal salt particles (SPZ-100F) was not added.

### Comparative Example II-2

The toner of Comparative Example II-2 was obtained in the same manner as Example II-1 (the same as Example I-1), except that in “1-1. Preparation of polymerizable monomer composition for core” of “1. Production of colored resin particles”, the materials used were changed according to Table 3 shown below; in “2. Production of toner”, the inorganic fine particles C (TG-820F) were not added in the second step of the external addition treatment; and the amounts of the added external additives were changed according to Table 3 shown below.

### Comparative Example II-3

The toner of Comparative Example II-3 was obtained in the same manner as Example II-1 (the same as Example I-1), except for the following.

In “1-1. Preparation of polymerizable monomer composition for core” of “1. Production of colored resin particles”, the materials used were changed according to Table 3 shown below.

In “2. Production of toner”, the inorganic fine particles C (TG-820F) were not added in the first step of the external addition treatment, and only the colored resin particles were subjected to mixing, stirring and drying.

Also in “2. Production of toner”, the external additives added in the external addition treatment were changed according to Table 3 shown below, and the peripheral speed of the stirring blades in the external addition treatment and the external addition treatment time were changed according to Table 3 shown below.

### [Measurement of Viscoelasticity]

As for the toners obtained in Examples and Comparative Examples of Example II series, in the same manner as Example I series, the temperature dependence curve for the loss tangent (tan δ) was obtained by the dynamic viscoelastic measurement.

The shape of the temperature dependence curve for the loss tangent (tan δ) of the toner obtained in each Example, was as described above in Example I series. The temperature dependence curve for the loss tangent (tan δ) of the toner obtained in Example II-1, was the same as the temperature dependence curve for the loss tangent (tan δ) of the toner obtained in Example I-1 of Example I series, and it is as shown in FIG. 1.

In the same manner as Example I series, from the obtained temperature-tan δ curve, the glass transition temperature (Tg), the loss tangent (tan δ) at the glass transition temperature (Tg) (that is, tan δ (Tg)), and the loss tangent (tan δ) at 100° C. (that is, tan δ (100° C.)) were determined, and the area of the trapezoid where the upper base, the lower base and the height were the value of tan δ (100° C.), the value of tan δ (Tg) and the value of 100−Tg, respectively, was calculated.

[Charge Amount Ratio (1800 s/180 s)]

First, 0.25 g of the toner and 9.75 g of a ferrite carrier (product name: EF-60, manufactured by: Powdertech Corporation, Mn—Mg—Sr—Fe type, spherical, non-coated with resin, average particle diameter 60 μm), which was a standard carrier, were put in a glass container having a volume of 30 cc (inner bottom diameter 30 mm, height 50 mm); in an environment at 23° C. and a relative humidity of 50%, a triboelectric charging treatment was carried out by stirring them by use of a roller mixer at a rotation of 160 rpm for 180 seconds; 0.2 g of a mixture of the toner and ferrite carrier after the triboelectric charging treatment, were put in a Faraday cage; and by use of a blow-off powder charge amount measuring device (product name: BLOW-OFF TYPE Q/M METER, manufactured by: TREK JAPAN), the toner was blown off for 30 seconds in a condition of a nitrogen gas pressure of 0.098 MPa, and the blow-off charge amount (μC/g) of the toner was measured. Based on the blow-off charge amount of the mixture, the blow-off charge amount (μC/g) of the toner after a stirring time of 180 seconds was calculated by the following formula (1).

$$Blow - off charge amount ( μ C / g ) of the toner = [ Blow - off charge amount ( μ C ) of the mixture ] / \{ [ Weight of the mixture ( 0.2 g ) ] \times [ \text{} Percentage of the toner contained in the mixture ( 2.5 \% ) ] \} \qquad Formula ( 1 )$$

In the method for obtaining the blow-off charge amount of the toner after a stirring time of 180 seconds, the blow-off charge amount of the toner after a stirring time of 1800 seconds was obtained in the same manner as the above-mentioned method, except that the stirring time was changed from 180 seconds to 1800 seconds.

Then, the ratio of the blow-off charge amount of the toner after a stirring time of 1800 seconds to the blow-off charge amount of the toner after a stirring time of 180 seconds (i.e., the charge amount ratio (1800 s/180 s)) was calculated.

### [Volume Average Particle Diameter (Dv)]

About 0.1 g of the toner was weighed out and put in a beaker. Next, as a dispersant, 0.1 mL of a surfactant aqueous solution (product name: DRIWEL, manufactured by: Fujifilm Corporation) was added thereto. In addition, 10 mL to 30 mL of ISOTON II was put in the beaker. The mixture was dispersed for 3 minutes with a 20 W (watt) ultrasonic disperser. Then, the volume average particle diameter (Dv) of the toner was measured with a particle size analyzer (product name: MULTISIZER, manufactured by: Beckman Coulter, Inc.) in the following conditions: aperture diameter: 100 μm, medium: ISOTON II, and the number of measured particles: 100,000 particles.

### [Evaluation]

The heat resistant temperature of each toner, the density decrease ratio of each toner, and the spouting of each toner when enduring in the high temperature and high humidity environment, were evaluated in the same manner as Example I series.

TABLE 3

| | | | Example II-1 | Example II-2 | Example II-3 | Example II-4 |
|---|---|---|---|---|---|---|
| Colored | Binder resin | ST (parts) | 72 | 72 | 72 | 72 |
| resin | | BA (parts) | 28 | 28 | 28 | 28 |
| particles | | DVB (parts) | 0.71 | 0.71 | 0.69 | 0.69 |
| | | AA6 (parts) | 0.1 | 0.1 | 0.1 | 0.1 |
| | | Mw | 5.04E+05 | 5.04E+05 | 4.93E+05 | 4.93E+05 |
| | | TET (Molecular weight | 1.25 | 1.25 | 1.25 | 1.25 |
| | | modifier) (parts) | | | | |
| | Charge control | 161P (parts) | 0.8 | 0.8 | 0.8 | 0.8 |
| | resin | | | | | |
| | Colorant | PY155 (parts) | 7 | 7 | 7 | 7 |
| | | PB15:3 (parts) | 0 | 0 | 0 | 0 |
| | | CB (parts) | 0 | 0 | 0 | 0 |
| External | Silica fine | TG820F (parts) | 0.40 | 0.40 | 0.20 | 0.20 |
| additive | particles | TG7120 (parts) | 0.53 | 0.53 | 0.53 | 0.53 |
| | | H05TA (parts) | 1.33 | 1.33 | 1.32 | 1.32 |
| | Fatty acid metal | SPZ-100F (parts) | 0.13 | 0.05 | 0.13 | 0.04 |
| | salt particles | SPX-100F (parts) | — | — | — | — |
| External | Treatment method | | Two-step | Two-step | Two-step | Two-step |
| addition | | | treatment | treatment | treatment | treatment |
| treatment | Peripheral speed (m/s) of stirring blades | | 46.6 | 46.6 | 46.6 | 46.6 |
| | External addition treatment time (min) | | 8.0 | 8.0 | 8.0 | 8.0 |
| Toner | Dv (μm) | | 7.0 | 7.0 | 7.1 | 7.1 |
| | Viscoelasticity | tanδ(100° C.) | 0.84 | 0.85 | 0.92 | 0.92 |
| | | tanδ(Tg) | 1.73 | 1.71 | 1.80 | 1.80 |
| | | Tg | 69.3 | 69.5 | 69.9 | 70.3 |
| | | Area of trapezoid (° C.) | 39.4 | 39.1 | 40.9 | 40.4 |
| | Charge amount | 1800 s (μC/g) | 27 | 21 | 30 | 21 |
| | Charge amount | 1800 s/180 s | 0.69 | 0.53 | 0.71 | 0.50 |
| | ratio | | | | | |
| | Density decrease ratio (%) | | 29 | 23 | 13 | 12 |
| | Spouting when enduring in high | | 1 | 1 | 0 | 0 |
| | temperature and high humidity environment | | | | | |
| | Heat resistant temperature (° C.) | | 57 | 57 | 57 | 57 |
| | | | Example II-5 | Example II-6 | Example II-7 | Example II-8 |
| Colored | Binder resin | ST (parts) | 72 | 72 | 72 | 72 |
| resin | | BA (parts) | 28 | 28 | 28 | 28 |
| particles | | DVB (parts) | 0.69 | 0.69 | 0.71 | 0.71 |
| | | AA6 (parts) | 0.1 | 0.1 | 0.1 | 0.1 |
| | | Mw | 4.93E+05 | 4.74E+05 | 4.90E+05 | 5.04E+05 |
| | | TET (Molecular weight | 1.25 | 1.25 | 1.25 | 1.25 |
| | | modifier) (parts) | | | | |
| | Charge control | 161P (parts) | 0.8 | 0.8 | 0.8 | 0.8 |
| | resin | | | | | |
| | Colorant | PY155 (parts) | 7 | 7 | 0 | 7 |
| | | PB15:3 (parts) | 0 | 0 | 7 | 0 |
| | | CB (parts) | 0 | 0 | 0 | 0 |
| External | Silica fine | TG820F (parts) | 0.20 | 0.20 | 0.40 | 0.40 |
| additive | particles | TG7120 (parts) | 0.53 | 0.54 | 0.53 | 0.53 |
| | | H05TA (parts) | 1.32 | 1.35 | 1.33 | 1.33 |
| | Fatty acid metal | SPZ-100F (parts) | 0.09 | 0.14 | 0.13 | — |
| | salt particles | SPX-100F (parts) | — | — | — | 0.13 |
| External | Treatment method | | Two-step | Two-step | Two-step | Two-step |
| addition | | | treatment | treatment | treatment | treatment |
| treatment | Peripheral speed (m/s) of stirring blades | | 46.6 | 46.6 | 46.6 | 46.6 |
| | External addition treatment time (min) | | 8.0 | 8.0 | 8.0 | 8.0 |
| Toner | Dv (μm) | | 7.1 | 7.0 | 7.0 | 7.0 |
| | Viscoelasticity | tanδ(100° C.) | 0.91 | 0.95 | 0.92 | 0.86 |
| | | tanδ(Tg) | 1.78 | 1.86 | 1.82 | 1.80 |
| | | Tg | 69.9 | 70.2 | 67.7 | 70.2 |
| | | Area of trapezoid (° C.) | 40.5 | 41.8 | 44.2 | 39.6 |
| | Charge amount | 1800 s (μC/g) | 26 | 31 | 27 | 26 |
| | Charge amount | 1800 s/180 s | 0.62 | 0.78 | 0.70 | 0.74 |
| | ratio | | | | | |

| | | | | |
|---|---|---|---|---|
| Density decrease ratio (%) | 11 | 5 | 25 | 28 |
| Spouting when enduring in high | 0 | 0 | 1 | 1 |
| temperature and high humidity environment | | | | |
| Heat resistant temperature (° C.) | 57 | 57 | 56 | 57 |

| | | | Comparative | Comparative | Comparative |
|---|---|---|---|---|---|
| | | | Example II-1 | Example II-2 | Example II-3 |
| Colored | Binder resin | ST (parts) | 72 | 81 | 77 |
| resin | | BA (parts) | 28 | 19 | 23 |
| particles | | DVB (parts) | 0.69 | 0.69 | 0.78 |
| | | AA6 (parts) | 0.1 | 0.1 | 0.25 |
| | | Mw | 4.93E+05 | 4.32E+05 | 4.21E+05 |
| | | TET (Molecular weight | 1.25 | 1.60 | 1.50 |
| | | modifier) (parts) | | | |
| | Charge control | 161P (parts) | 0.8 | 0.8 | 1.6 |
| | resin | | | | |
| | Colorant | PY155 (parts) | 7 | 7 | 0 |
| | | PB15:3 (parts) | 0 | 0 | 0 |
| | | CB (parts) | 0 | 0 | 7 |
| External | Silica fine | TG820F (parts) | 0.20 | 0.20 | 0.10 |
| additive | particles | TG7120 (parts) | 0.53 | 0.54 | 0.08 |
| | | H05TA (parts) | 1.32 | 1.35 | 0.20 |
| | Fatty acid metal | SPZ-100F (parts) | 0.00 | 0.13 | 0.20 |
| | salt particles | SPX-100F (parts) | — | — | — |
| External | Treatment method | | Two-step | Two-step | One-step |
| addition | | | treatment | treatment | treatment |
| treatment | Peripheral speed (m/s) of stirring blades | | 46.6 | 46.6 | 32.2 |
| | External addition treatment time (min) | | 8.0 | 8.0 | 6.0 |
| Toner | Dv (μm) | | 7.1 | 7.0 | 6.5 |
| | Viscoelasticity | tanδ(100° C.) | 0.92 | 1.05 | 1.27 |
| | | tanδ(Tg) | 1.80 | 2.43 | 2.70 |
| | | Tg | 70.1 | 80.7 | 76 |
| | | Area of trapezoid (° C.) | 40.7 | 33.6 | 48.1 |
| | Charge amount | 1800 s (μC/g) | 17 | 28 | 39 |
| | Charge amount | 1800 s/180 s | 0.44 | 0.71 | 0.91 |
| | ratio | | | | |

| | | | |
|---|---|---|---|
| Density decrease ratio (%) | 12 | 45 | 5 |
| Spouting when enduring in high | 3 | 0-1 | 3 |
| temperature and high humidity environment | | | |
| Heat resistant temperature (° C.) | 57 | 57 | 50 |

The abbreviations in Table 3 and the notation of the external addition treatment method in Table 3 are the same as Tables 1 and 2.

### [Consideration]

The toner of Comparative Example II-1 did not contain fatty acid metal salt particles as the external additive, and the charge amount ratio (1800 s/180 s) was less than 0.50. Accordingly, when the endurance test was carried out in the high temperature and high humidity environment, the toner of Comparative Example II-1 spouted from the whole surface of the developing roller.

As for the toner of Comparative Example II-2, the Tg was more than 75.0° C., and the area of the trapezoid was less than 35.0. Accordingly, the density decrease ratio of the solid area before and after the rubbing test was high, that is, the toner of Comparative Example II-2 was poor in low-temperature fixability.

As for the toner of Comparative Example II-3, the area of the trapezoid was more than 48.0. Accordingly, the toner was poor in storage stability due to the low heat resistant temperature, that is, easy occurrence of blocking during toner storage. Moreover, in the endurance test carried out in a high temperature and high humidity environment, the toner of Comparative Example II-3 spouted from the whole surface of the developing roller.

As for the toners of Examples II-1 to II-8, the glass transition temperature (Tg) specified from the temperature-tan δ curve at a measurement frequency of 24 Hz satisfied 65.0° C.≤Tg (C)≤75.0° C.; the area of the trapezoid where the upper base, the lower base and the height were the value of tan δ (100° C.), the value of tan δ (Tg) and the value of 100−Tg, respectively, was 35.0 or more and 48.0 or less; and the charge amount ratio (1800 s/180 s) was 0.50 or more and 1.00 or less. Accordingly, the toners of Examples II-1 to II-8 were excellent in storage stability due to the high heat resistant temperature, that is, hardly occurrence of blocking during toner storage; the density decrease ratio of the solid area before and after the rubbing test was high, that is, the toners of Examples II-1 to II-8 were excellent in low-temperature fixability; and the toners did not spout even when the endurance test was carried out in the high temperature and high humidity environment, that is, the toners of Examples II-1 to II-8 were toners such that the spouting of the toners when enduring in the high temperature and high humidity environment, was suppressed.

1. A toner comprising colored resin particles containing a binder resin, a colorant, a softening agent and a charge control agent, and an external additive,
wherein a glass transition temperature (Tg) specified from a temperature dependence curve for a loss tangent (tan δ) of the toner, which is obtained by a dynamic viscoelastic measurement of the toner at a measurement frequency of 24 Hz, satisfies 65.0° C.≤Tg (° C.)≤75.0° C.;
wherein, in the temperature dependence curve for the loss tangent (tan δ) where tan δ (Tg) is a loss tangent (tan δ) at Tg and tan δ (100° C.) is a loss tangent (tan δ) at 100° C., an area of a trapezoid where the upper base, lower base and height are a value of tan δ (100° C.), a value of tan δ (Tg) and a value of 100−Tg, respectively, is 35.0 or more and 48.0 or less;
wherein a conditioned bulk density obtained by use of a powder flowability analyzing device is 0.527 g/mL or more and 0.550 g/mL or less; and
wherein a flowability is 80% or more.

2. The toner according to claim 1, wherein the external additive contains fatty acid metal salt particles, and a number average primary particle diameter of the fatty acid metal salt particles is 1.0 μm or less.

3. The toner according to claim 2, wherein a content of the fatty acid metal salt particles is 0.01 parts by mass or more and 0.19 parts by mass or less, with respect to 100 parts by mass of the binder resin.

4. The toner according to claim 1, wherein a BET specific surface area is 1.00 m²/g or more and 2.00 m²/g or less.

5. The toner according to claim 1, wherein the loss tangent (tan δ) at the glass transition temperature (Tg) is 1.50 or more and 2.60 or less.

6. A toner comprising colored resin particles containing a binder resin, a colorant, a softening agent and a charge control agent, and an external additive,
wherein fatty acid metal salt particles are contained as the external additive;
wherein a glass transition temperature (Tg) specified from a temperature dependence curve for a loss tangent (tan δ) of the toner, which is obtained by a dynamic viscoelastic measurement of the toner at a measurement frequency of 24 Hz, satisfies 65.0° C.≤Tg (° C.)≤75.0° C.;
wherein, in the temperature dependence curve for the loss tangent (tan δ) where tan δ (Tg) is a loss tangent (tan δ) at Tg and tan δ (100° C.) is a loss tangent (tan δ) at 100° C., an area of a trapezoid where the upper base, lower base and height are a value of tan δ (100° C.), a value of tan δ (Tg) and a value of 100−Tg, respectively, is 35.0 or more and 48.0 or less; and
wherein a ratio of a blow-off charge amount of the toner after a stirring time of 1800 seconds to a blow-off charge amount of the toner after a stirring time of 180 seconds, both of which are measured by the following charge amount measurement method, is 0.50 or more and 1.00 or less:
[charge amount measurement method]
first, 0.25 g of the toner and 9.75 g of a spherical, non-coated Mn—Mg—Sr—Fe type ferrite carrier having an average particle diameter of 60 μm, are put in a glass container having a volume of 30 cc (inner bottom diameter 30 mm, height 50 mm); in an environment at 23° C. and a relative humidity of 50%, a triboelectric charging treatment is carried out by stirring them by use of a roller mixer at a rotation of 160 rpm for a predetermined time; 0.2 g of a mixture of the toner and ferrite carrier after the triboelectric charging treatment, is put in a Faraday cage; and by use of a blow-off powder charge amount measuring device, the toner is blown off for 30 seconds in a condition of a nitrogen gas pressure of 0.098 MPa, and the blow-off charge amount (μC/g) of the toner is measured.

7. The toner according to claim 6, wherein a number average primary particle diameter of the fatty acid metal salt particles is 1.0 μm or less.

8. The toner according to claim 6, wherein a content of the fatty acid metal salt particles is 0.01 parts by mass or more and 0.19 parts by mass or less, with respect to 100 parts by mass of the binder resin.

9. The toner according to claim 6, wherein the loss tangent (tan δ) at the glass transition temperature (Tg) is 1.50 or more and 2.60 or less.
